(19) United States
(12) Patent Application Publication
(10) Pub. No.: US 2019/0224628 A1
(43) Pub. Date: Jul. 25, 2019

(54) Porous Graphene-Based Films And Processes For Preparing The Films

(71) Applicant: Swinburne University of Technology, Hawthorn (AU)

(72) Inventors: Han Lin, Boxhill (AU); Baohua Jia, Balwyn North (AU)

(73) Assignee: Swinburne University of Technology, Hawthorn (AU)

(21) Appl. No.: 16/329,545

(22) PCT Filed: Aug. 29, 2017
(86) PCT No.: PCT/AU2017/050921

§ 371 Date: Feb. 28, 2019

(30) Foreign Application Priority Data
Aug. 30, 2016 (AU) 2016903455

(51) Int. Cl. B01D 67/00; B01D 69/02; B01D 69/12; B01D 71/02; C01B 32/198; C01B 32/192

(52) U.S. Cl. CPC B01D 67/009; B01D 67/0079; B01D 69/02; B01D 69/125; B01D 71/021; B01D 2323/34; C01B 32/192; B01D 2325/02; B01D 2325/04; B01D 2323/28; B01D 2323/30; C01B 32/198

(57) ABSTRACT

The invention relates in general to porous graphene-based films. In particular, the invention relates to a process for the preparation of a porous graphene-based films comprising reduced graphene oxide. The invention also relates to porous graphene-based films prepared by the process and to uses of such porous graphene-based films, in particular, in filtration applications. The invention further relates to porous multi-zone graphene-based films comprising different zones of different porosity.

### TECHNICAL FIELD

The invention relates in general to porous graphene-based films. In particular, the invention relates to a process for the preparation of a porous graphene-based films comprising reduced graphene oxide. The invention also relates to porous graphene-based films prepared by the process and to uses of such porous graphene-based films, in particular, in filtration applications. The invention further relates to porous multi-zone graphene-based films comprising different zones of different porosity.

### BACKGROUND

Membranes for filtration applications have traditionally been prepared from polymeric materials or inorganic materials such as ceramics, silica or metals. However, membranes formed from these materials have a number of challenges and limitations. Some of the limitations associated with existing membrane materials include the inability to form pores of a small size or of a precise size distribution, slow flow rates through the membrane, limited thermal or chemical resistance and a tendency to trap particles, leading to membrane fouling.

Graphene is an allotrope of carbon. It is a material in the form of a two-dimensional sheet composed of a monolayer of sp²-bonded carbon atoms arranged in a hexagonal honeycomb structure. Graphene-based films have been investigated for use in a range of applications due to the unique electronic, chemical and mechanical properties of graphene.

Graphene oxide films composed of stacked graphene oxide sheets have been used as filtration membranes. The interlayer space between the stacked graphene oxide sheets form nanochannels that permit the passage of small-sized molecular species while larger molecular species are blocked. While graphene oxide films can provide for efficient molecular separations, the interlayer separation distances that can be achieved on a practical scale may limit the sieving capability of such films.

There remains a need for graphene-based films with adjustable sieving capabilities, which can be tailored to suit a variety of filtration applications.

There also remains a need for a process that can produce graphene-based films having adjustable sieving properties in a convenient manner.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

### SUMMARY OF THE INVENTION

The present invention relates to porous graphene-based films and in particular, relates to porous graphene-based films comprising sheets of reduced graphene oxide and to processes for preparing such graphene-based films.

In one aspect, the present invention provides a process for preparing a porous graphene-based film comprising the steps of:
providing a porous graphene oxide film comprising a multilayer array of graphene oxide sheets; and
subjecting the porous graphene oxide film to a photo-reduction process whereby an oxygen containing functional group situated (i) in a pore of a graphene oxide sheet and/or (ii) in between two or more graphene oxide sheets is reduced, to thereby form a porous graphene-based film comprising at least one reduced graphene oxide sheet,
wherein the reduced graphene oxide sheet has a pore of a different size and/or is separated from a sheet overlapping it by a different interlayer distance, relative to a corresponding graphene oxide sheet in the graphene oxide film prior to the photo-reduction step.

The photo-reduction process may be performed by irradiating the porous graphene oxide film with a suitable source of light or radiation in a beam.

In another aspect, the present invention provides a porous graphene-based film prepared by the process of any one of the embodiments described herein.

The present invention further provides a filtration membrane comprising a porous graphene-based film prepared by the process of any one of the embodiments described herein.

In a further aspect, the present invention provides a porous multi-zone graphene-based film comprising:
a reduced graphene oxide zone comprising porous reduced graphene oxide; and
at least one other zone comprising porous graphene oxide or porous reduced graphene oxide,
wherein the at least one other zone is of a different porosity than the reduced graphene oxide zone.

The present invention also provides a method of removing a target solute from a solution comprising the step of filtering a solution comprising the target solute through a filtration membrane according to one or more embodiments described herein, whereby the target solute is selectively retained by the membrane.

### BRIEF DESCRIPTION OF THE FIGURES

Embodiments of the invention will now be described with reference to the following non-limiting drawings in which:

FIG. 1 is a schematic diagram of a process for preparing a porous graphene-based reduced graphene oxide film with a laser beam in accordance with one embodiment of the invention.

FIG. 2 shows XPS spectra obtained for a porous graphene oxide (GO) film: (a) before reduction, (b) after reduction by irradiation once with laser diode, and (c) after reduction by irradiation twice with laser diode.

FIG. 3 shows Raman spectra obtained for a porous graphene oxide (GO) film: (a) before reduction, (b) after reduction by irradiation once with laser diode, and (c) after reduction by irradiation twice with laser diode.

FIG. 4 shows Raman spectra obtained for a porous self-assembled graphene oxide (GO) film: (a) before reduction, (b) after reduction by irradiation with a femtosecond laser.

FIG. 5 shows XPS spectra obtained for a porous graphene oxide (GO) film: (a) before reduction, and after reduction by irradiation with a femtosecond laser at a pulse width of (b) 85 fs, (c) 200 fs, (d) 340 fs and (e) 550 fs.

FIG. 6 shows (a) Raman spectra obtained for a porous graphene oxide (GO) film and porous graphene-based films prepared following reduction with a femtosecond laser at various pulse widths, and (b) a graph illustrating the I_{D}:I_{G} ratio and I_{2D}:I_{G} ratio for the various graphene-based films.

FIG. 7 shows graphs of simulated experiments to analyse (a) change in pore size and (b) change in interlayer separation distance as a function of laser power when a porous graphene oxide film is subjected to photo-reduction.

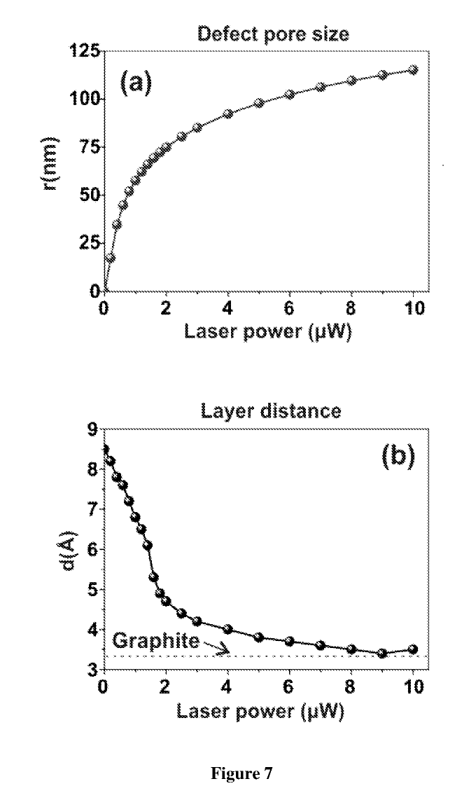

FIG. 8 is a schematic diagram showing a porous multi-zone graphene-based films accordance with embodiments of the invention comprising zones of different porosity arranged in different patterns.

FIG. 9 shows x-ray diffraction (XRD) spectra obtained for a porous graphene-based film following irradiation with laser diode working at a power of: (a) 5 mW, (b) 10 mW, (c) 20 mW, (d) 30 mW, (e) 40 mW, and (f) 50 mW.

FIG. 10 shows a graph illustrating the change in interlayer spacing distance as a function of laser power when a porous graphene oxide (GO) film is irradiated with a laser diode.

FIG. 11 shows Raman spectra obtained for porous graphene-based forms following irradiation of a GO film with a femtosecond laser working at different laser pulse widths.

FIG. 12 shows a graph illustrating the change in defect density as a function of laser pulse width with a porous GO film is irradiated with a femtosecond laser.

FIG. 13 shows a scanning electron micrograph of a porous graphene-based film in 3D form.

FIG. 14 shows an image of a porous multi-zone graphene-based film having a patterned area comprising crosslinked and reduced graphene oxide.

### DETAILED DESCRIPTION OF THE INVENTION

As used herein, the singular forms “a,” “an,” and “the” designate both the singular and the plural, unless expressly stated to designate the singular only.

The term “about” and the use of ranges in general, whether or not qualified by the term about, means that the number comprehended is not limited to the exact number set forth herein, and is intended to refer to ranges substantially within the quoted range while not departing from the scope of the invention. As used herein, “about” will be understood by persons of ordinary skill in the art and will vary to some extent on the context in which it is used. If there are uses of the term which are not clear to persons of ordinary skill in the art given the context in which it is used, “about” will mean up to plus or minus 10% of the particular term.

Percentages (%) referred to herein are based on weight percent (w/w or w/v) unless otherwise indicated.

### Graphene Oxide (GO) Film

The process of one aspect of the present invention provides a porous graphene oxide (GO) film and subjects that graphene oxide film to a reduction process to form a porous graphene-based film having tailored sieving properties.

Graphene oxide (“GO”) is an oxidised form of graphene, which comprises oxygen-containing functional groups that can be reduced to convert the graphene oxide into reduced graphene oxide (“rGO”).

The present invention enables oxygen containing functional groups in one or more graphene oxide sheets in the porous GO film to be selectively reduced to convert the graphene oxide into reduced graphene oxide (rGO). The selective reduction of oxygen containing functional groups enables tailored sieving properties for the resultant graphene-based film to be achieved.

The porous graphene oxide film employed in the process of the embodiments described herein is a three-dimensional film, which comprises a multilayer array comprising graphene oxide sheets.

As used herein, the term “multilayer array” generally refers to an arrangement comprising a plurality of planar graphene-based sheets that are stacked on one another in an overlapping manner to resemble a layered structure. Planar sheets in the multilayer array may partially overlap or completely overlap one another. The multi-layer array is generally a three-dimensional arrangement.

The expression “graphene-based” may be used herein as a convenient reference to material comprising graphene, including graphene oxide and reduced graphene oxide.

Planar sheets in a multilayer may be composed of graphene oxide (e.g. in the case of a graphene oxide film). Alternatively, the sheets may be composed of reduced graphene oxide or mixtures of graphene oxide and reduced graphene oxide (e.g. in the case of a graphene-based film).

A “graphene-based film” as described herein comprises a multilayer array of graphene-based sheets that will generally include at least one reduced graphene oxide sheet and may include a plurality of reduced graphene oxide sheets, optionally in combination with one or more graphene oxide sheets.

The porous graphene oxide film used herein comprises graphene oxide (GO) sheets, wherein at least some of the graphene oxide sheets comprise one or more pores. In some embodiments, a portion of the graphene oxide sheets in the multilayer array comprise at least one pore, while a further portion of the graphene oxide sheets do not comprise a pore. In other embodiments, each graphene oxide sheet in the graphene oxide film comprises at least one pore. A skilled person would appreciate that an individual graphene oxide sheet in the graphene oxide film can comprise a single pore or a plurality of pores.

Pores in a graphene oxide sheet are carbon atom vacancies in the plane of the sheet, which disrupt the regular hexagonal carbon lattice of the sheet. Such pores may be distributed randomly or with high regularity in a graphene oxide sheet. Depending on their diameters, the pores may be classified as micropores (diameters below 2 nm), mesopores (diameters in the range of from about 2 nm to about 50 nm) or macropores (diameters above 50 nm).

Graphene oxide sheets in the porous graphene oxide film are also separated or spaced apart from one another in the multilayer structure. Accordingly, an interlayer space exists between the graphene oxide sheets. The extent (i.e. distance) by which graphene oxide sheets are separated from one another when in the graphene oxide film may be referred to herein as the “separation distance”, “interlayer distance” or “interlayer spacing” between the sheets. The interlayer space can provide nanochannels within the porous graphene oxide film.

The porous graphene oxide film employed in the process of the embodiments described herein comprises at least one oxygen containing functional group. In some embodiments, the graphene oxide film may comprise a plurality of oxygen containing functional groups.

Such oxygen containing functional groups are generally present in at least one graphene oxide sheet that forms part of the porous graphene oxide film.

As used herein, the term “oxygen containing functional group” is generally a reference to functional groups such as epoxides, hydroxyls, ketones, ketone pairs, phenols, carboxyls, cyclic ethers and the like, that are covalently bound to a carbon atom of a graphene oxide sheet. Such oxygen containing functional groups may be a result of oxidation reactions.

In one set of embodiments, the porous graphene oxide film comprises an oxygen containing functional group situated in at least one selected from (i) a pore of a graphene oxide sheet and (ii) between two or more graphene oxide sheets.

In one set of embodiments, the porous graphene oxide film comprises an oxygen containing functional group situated both in a pore of a graphene oxide sheet and in between two or more graphene oxide sheets.

Oxygen containing functional groups situated in a pore of a graphene oxide sheet may be positioned at the edge of the pore. Pores in a graphene oxide sheet may comprise at least one oxygen containing functional group and may comprise a plurality of oxygen containing functional groups. When an individual graphene oxide sheet comprises a plurality of pores, each pore may comprise at least one oxygen containing functional group.

Oxygen containing functional groups that are situated in between two or more graphene oxide sheets may be covalently bound to a surface of a graphene oxide sheet and extend from the basal plane of the graphene oxide sheet into the interlayer space that exists between overlapping sheets. In this manner, overlapping graphene oxide sheets can be spaced apart or separated from one another by the oxygen containing functional groups. The porous graphene oxide film comprises at least one oxygen containing functional group, and may comprise a plurality of oxygen containing functional groups, situated in between two or more graphene oxide sheets.

The porous graphene oxide film employed in the process of the embodiments described herein may be obtained from commercial sources. Alternatively, the porous graphene oxide film may be synthesised from graphite.

In one set of embodiments, porous graphene oxide films useful for the embodiments described herein have a high oxidation degree. A porous graphene oxide film having a high oxidation degree may comprise an amount of oxygen containing functional groups to provide an oxygen content of at least about 15%, preferably at least about 20%, more preferably at least about 25%, in the graphene oxide film.

The oxygen content of the porous graphene oxide film may be determined by suitable techniques. For example, oxygen content and hence oxidation degree may be determined by X-ray photoelectron spectroscopy (XPS), which measures the type and percentage of each type of chemical element present in a material. In one form, graphene oxide sheets forming the graphene oxide film have a carbon to oxygen (C:O) ratio as determined by XPS in a range of from about 2:1 to about 4:1, preferably from about 2.5:1 to 3:1.

Porous graphene oxide films with a high oxidation degree may have a large number of pores in the graphene oxide sheets as well as a large interlayer spacing between the sheets. For instance, a porous graphene oxide film with a high degree of oxidation may have graphene oxide sheets that are separated by a distance of up to 8 Å. Thus, the use of a porous graphene oxide film with a high oxidation degree may be advantageous as it can enable the sieving characteristics of the resultant reduced graphene oxide film to be tuned within a large range.

In one form, the process of the invention employs a porous graphene oxide film prepared from graphite. Graphite may be oxidised and exfoliated to produce a graphene oxide solution, which is then used to form a porous graphene oxide film. The graphene oxide film produced from the oxidised and exfoliated graphite may have a high oxidation degree.

In some embodiments, the process of the invention may further comprise the steps of:
oxidising graphite to form graphite oxide;
exfoliating the graphite oxide in a solvent to form a graphene oxide solution; and
forming a porous graphene oxide film as described herein from the graphene oxide solution.

As discussed herein, the porous graphene oxide film formed from the graphene oxide solution will generally comprise a multilayer array of graphene oxide sheets.

Graphite may be oxidised using conventional methods to produce graphite oxide. In some embodiments, oxidising methods such as Hummers method (Journal of the American Chemical Society, 1958, 80(6), 1339) or modified Hummers method (ACS nano, 2010, 4(8), 4806) may be employed.

The graphite oxide that is produced from the oxidation of graphite comprises a plurality of planar graphene oxide sheets, with each of the graphene oxide sheets comprising at least one oxygen containing functional group.

The graphite oxide is exfoliated to produce sheets of graphene oxide. The exfoliation of the graphite oxide may be performed using exfoliation techniques and conditions known in the art.

In some embodiments, the graphite oxide can be suspended in a solvent and exfoliated in the solvent under conditions sufficient to cause separation of the graphene oxide sheets, resulting in the formation of a graphene oxide solution. The graphene oxide solution comprises separated sheets of graphene oxide suspended in the solvent. The separated graphene oxide sheets may be in monolayer or few-layer form. Few-layer form may comprise from 2 to 10 sheets.

The graphite oxide may be suspended in any suitable solvent. In one set of embodiments, the graphite oxide is suspended in an aqueous solvent. In one embodiment the aqueous solvent is substantially free of organic solvent. In one preference, the aqueous solvent is water. The use of an aqueous solvent allows the graphene oxide film to be prepared in an environmentally friendly manner.

The exfoliation of graphite oxide in a solution can be performed using a suitable exfoliation technique.

In one set of embodiments, a graphite oxide in a solution may be subjected to mechanical exfoliation to produce graphene oxide sheets, which are then dispersed in the solvent. Mechanical exfoliation may be achieved using sonication.

A person skilled in the art would appreciate that sonication involves the application of sound energy to agitate the graphite oxide and ultimately result in disruption of the graphene oxide lattice layers in the graphite material. Disruption of the lattice layers leads to separation of the layers of graphene oxide sheets. Sonication means and conditions known to be useful for exfoliating graphite oxide may be used. Sonication may be performed with a sonifier or sonication bath.

In some embodiments, graphite oxide may be sonicated at a frequency in a range of from about 20 kHz to about 400 kHz, preferably at a frequency of about 20 kHz.

In one set of embodiments, graphite oxide is ultrasonicated to produce graphene oxide sheets.

Sonication may be carried out for a time period ranging from seconds to hours. Time periods may vary depending on for example, the quantity of graphite oxide to be exfoliated and the frequency of sonication. In one set of embodiments, the graphite oxide may be sonicated for a time period in a range of from about 5 minutes to several hours, preferably from about 20 minutes to about 1 hour, more preferably for about 30 minutes.

After exfoliation of the graphite oxide in solution, a graphene oxide solution is then formed. The graphene oxide solution may comprise graphene oxide in monolayer and/or in few-layer form. Few-layer form may comprise from 2 to 10 sheets.

At least some of the graphene oxide in the graphene oxide solution comprise at least one pore. In some embodiments, at least some of the graphene oxide in the solution comprise a plurality of pores. The pores may arise as a result of defects that are introduced in the sheets of graphene oxide.

The graphene oxide solution can be used to form a porous graphene oxide film. The graphene oxide film may be prepared using conventional film formation techniques that would be known to a skilled person.

In one set of embodiments, formation of a porous graphene oxide film involves applying a graphene oxide solution to a substrate to form a coating and removing the solvent from the coating to leave a porous graphene oxide film on the substrate. If desired, the resulting graphene oxide film may be removed from the substrate. For example, the film may be peeled off the substrate.

Substrates that may be used for formation of a porous graphene oxide film include polymer substrates comprising a suitable polymer. Polymer substrates may be porous and have a porosity that is higher than that of the porous graphene oxide film. In one embodiment, a porous polymer substrate comprising polyethersulfone (PES) may be used.

In some embodiments, the porous graphene oxide film may be prepared by at least one film forming technique selected from filtration, spin coating, spray coating and drop casting.

In one set of embodiments, a graphene oxide solution is subjected to a filtration process to form a porous graphene oxide film. An example of a filtration process is described in Dikin, D. A. et al, Nature 448, 457-460 (2007). The graphene oxide solution may be passed through a filter substrate in order to form a porous graphene oxide film. The porous graphene oxide in the solution is thereby retained on the filter substrate while the solvent passes through. Filtration of the graphene oxide solution may be aided by a vacuum filtration apparatus. The overall dimensions of the porous graphene oxide film may be influenced by the filtration setup, including the size of the filter substrate, while the thickness of the graphene oxide film may be controlled by adjusting the amount of graphene oxide in the solution and the time of filtration. A free-standing (i.e. unsupported) porous graphene oxide film may be produced by removing the as prepared film from the filter substrate.

In one set of embodiments, formation of the porous graphene oxide film may involve a spray coating process. An example of a spray coating process is described in Moon, In Kyu, et al, Scientific Reports 3 (2013). In some embodiments, a graphene oxide solution is sprayed onto a substrate to form a porous graphene oxide film. The graphene oxide solution may be sprayed onto the substrate using a suitable spray device, such as a spray gun. The sprayed graphene oxide solution thereby coats the surface of the substrate. In carrying out the process, the substrate may be heated to allow the solvent from the sprayed graphene oxide solution to be rapidly removed by evaporation after the coating is applied. When the solvent is an aqueous solvent (for example, water), the substrate may be heated at a temperature of up to about 80° C. The thickness of the porous graphene oxide film may be controlled by the concentration of graphene oxide in the solution and/or the amount of graphene oxide solution applied to the substrate. Application of the graphene oxide solution can be controlled by adjusting the flow rate of the solution and/or the spray time. The flow rate of the graphene oxide solution spray can be controlled by the nozzle size of the spray device and the pressure at which the spray of graphene oxide solution is applied.

In one set of embodiments, formation of the porous graphene oxide film may involve a spin coating process. Spin coating may be used to deposit uniform thin graphene oxide film onto flat substrates. An example of spin coating process is described in Guo, Yunlong, et al, ACS nano 4.10 (2010): 5749-5754. In some embodiments, a graphene oxide solution may initially be applied to a stationary or spinning substrate that is rotating at a low speed. The substrate is subsequently rotated at high speed in order to spread the graphene oxide solution on the substrate by centrifugal force. Rotation is continued while the fluid spins off the edges of the substrate, until the desired film thickness is achieved. The thickness of porous graphene oxide film may be controlled by the spinning speed, which can vary from 400 to 6000 revolutions per minute (rpm).

In one set of embodiments, formation of the porous graphene oxide film may involve a drop casting process. An example of a drop casting process is described in El-Kady, Maher F., et al, Science 335.6074 (2012): 1326-1330. In such embodiments, a graphene oxide solution may be dropped onto a substrate to form a coating on the substrate. The coating is then dried under ambient atmospheric conditions to remove the solvent from the coating and form a graphene oxide film. To accelerate the drying process, a flow of air may be passed over the coating. The size of the substrate and/or the size of the drops may determine the size of the porous graphene oxide film. The thickness of the graphene oxide film may be determined by the concentration of graphene oxide in the solution.

### Spacers

In one form of the embodiments, the porous graphene oxide film may further comprise one or more spacers. When present, the spacers are generally situated in between two or more graphene oxide sheets of the graphene oxide film.

Spacers may be derived from one or more suitable spacer compounds. For example, spacers may be polymeric spacers, which are derived from one or more polymeric compounds. When present, spacers may act in conjunction with oxygen containing functional groups to control the interlayer spacing between graphene oxide sheets in the graphene oxide film. For instance, spacers may help to enlarge the interlayer spacing between graphene oxide sheets, such that the separation distance between the sheets is greater than that observed without the spacer.

Depending on the nature of the spacer, the mechanical properties of the porous graphene oxide film and consequently, the porous graphene-based film, may be altered by the presence of the spacer.

In some embodiments, spacers can act to crosslink graphene oxide sheets, such that a porous crosslinked graphene oxide film is then produced. In this manner, at least two graphene oxide sheets in the multilayer array may be chemically bonded together via crosslinks provided by the spacer.

In some embodiments, a porous crosslinked graphene oxide film comprises at least one graphene oxide sheet that is crosslinked to a graphene oxide sheet overlapping it via a spacer. Preferably, the spacer is bonded to each of the graphene oxide sheets via chemical bonds and extends between the graphene oxide sheets.

Crosslinking can be used to form a porous crosslinked graphene-based film. Crosslinking reactions may occur prior to, during, or after the reduction process described herein.

In some embodiments, crosslinking occurs prior to the reduction process so as to produce a porous crosslinked graphene oxide film. A crosslinked graphene oxide film may help to ensure that the resulting porous graphene-based film formed after the reduction process maintains its physical integrity and does not degrade or dissolve when in use.

In other embodiments, crosslinking occurs during the reduction process. Thus in such embodiments, the porous graphene oxide film may comprise a spacer compound dispersed therein prior to the reduction process. The spacer compound dispersed in the GO film is capable of forming a crosslink when the film is subjected to the reduction process. During the reduction process, crosslinking and the reduction of one or more oxygen containing functional groups can take place simultaneously, resulting in the formation of a porous crosslinked graphene-based film.

In set of embodiments, a porous graphene oxide film comprising a spacer compound is irradiated to subject the film to a photo-reduction process, whereby the film is crosslinked and at least one oxygen containing functional group situated (i) in a pore of a graphene oxide sheet and/or (ii) in between two or more graphene oxide sheets is reduced during the photo-reduction process, to thereby form a porous crosslinked graphene-based film.

In some embodiments, crosslinking occurs after the reduction process. Accordingly, a porous graphene-based film is initially produced and is then subsequently crosslinked.

Useful spacer compounds may be of any suitable molecular weight or size. The size of the spacer compound may influence the interlayer spacing and hence separation distance between graphene oxide sheets, with larger (i.e. higher molecular weight) spacers giving rise to larger separation distances.

Crosslinking may proceed via covalent or non-covalent bonding interactions, or mixtures thereof. Generally, crosslinking would be understood by a skilled person to result in the formation of chemical bonds (either covalent of non-covalent bonds) between atoms on different compounds or molecules.

A porous covalently crosslinked graphene oxide film may be produced when a spacer compound contains functional groups that are capable of covalently reacting with oxygen containing functional groups (such as epoxy or carboxyl functional groups) present on a surface of a graphene oxide sheet, resulting in covalent attachment of the spacer to the graphene oxide sheet. The porous crosslinked graphene oxide film may then subsequently undergo a reduction process as described herein to form a porous crosslinked graphene-based film.

A porous covalently crosslinked graphene-based film may be produced when a porous graphene oxide film comprising a spacer compound is subjected to a photo-reduction process by irradiation, preferably with an appropriate source of light or radiation in a beam. During the irradiation step, heat may be generated by the beam of light or radiation, leading to thermally induced covalent crosslinking of the film via the spacer compound. During the irradiation step, at least one oxygen containing functional group in the porous GO film is also reduced. Thus crosslinking and reduction of the GO film may be achieved single step by irradiating the film.

A spacer compound may have any suitable functional group. In some embodiments, the spacer compound may comprise a functional group selected from the group consisting of hydroxyl, amino, amido and thiol, and mixtures thereof. A spacer compound may be multifunctional and may comprise two or more of these functional groups.

Metal nanoparticles that are capable of covalently bonding with oxygen containing functional groups of a graphene oxide sheet may also be used as spacer compounds.

In one set of embodiments, the spacer compound may be a polyol. Accordingly, the graphene oxide film or graphene-based film may be crosslinked by a spacer derived from at least one polyol compound.

In some embodiments, the spacer compound may be a polymer compound. An exemplary polymer compound may be a polymeric polyol.

Polyol compounds are multifunctional and comprise two or more hydroxyl functional groups. The hydroxyl functional groups are generally terminal functional groups. Polyol compounds suitable as spacers for the graphene oxide film may comprise two, three, four or more hydroxyl functional groups.

When a polyol compound is used as a spacer compound to crosslink a film, such as graphene oxide film or a graphene-based film, covalent attachment of the polyol to graphene oxide sheet in the film may be via functional groups, such as ester (—C(O)O), ether (—O—) or anhydride (—(O)COC(O)—) groups, which are formed between the polyol and the graphene oxide sheet.

When covalent reactions occur between a polyol compound comprising at least two terminal hydroxyl functional groups and two separate overlapping graphene oxide sheets, a crosslink can thus be formed between the graphene oxide sheets. For instance, a first terminal hydroxyl group on the polyol compound may covalently react with an oxygen containing functional group on a first graphene oxide sheet while a second terminal hydroxyl group on the polyol compound covalently reacts with an oxygen containing functional group on a second graphene oxide sheet. The polyol therefore extends between the first and second graphene oxide sheets and acts as a crosslinker between the graphene oxide sheets.

In some embodiments, the spacer may be derived from a polyol compound selected from the group consisting of ethylene glycol (EG), 1,2-propylene glycol (PG), butylene glycol (BG), 1,6-hexylene glycol (HG), neopentyl glycol (NPG), glycerol (GL), pentaerythritol (PER), and mixtures thereof. Thus in some embodiments a porous graphene oxide film or porous graphene-based film as described herein may comprise one or more spacers derived from at least one or a mixture of the aforementioned polyols.

A porous non-covalently crosslinked graphene oxide film may be produced when a spacer compound is capable of interacting with a graphene oxide sheet via non-covalent bonding interactions. Examples of non-covalent bonding interactions include ionic bonding and hydrogen bonding interactions. The spacer is therefore bound to the graphene oxide sheets via non-covalent bonds and crosslinks overlapping graphene oxide sheets via the non-covalent bonds, producing a porous non-covalently crosslinked graphene oxide film.

In one set of embodiments, the porous graphene oxide film is crosslinked via ionic or electrostatic interactions. In such embodiments, the porous graphene oxide film may comprise a spacer derived from an ionisable spacer compound.

An ionisable spacer compound is a compound that is capable of carrying a net charge at a selected pH. Ionisable spacer compounds may comprise functional groups such as carboxylic acid, carboxylic acid ester, amino, amido, nitro, phospho, sulpho, thiol, and the like.

In some embodiments, the ionisable spacer compound may be selected from the group consisting of pyrenebutanoic acid succinimidyl ester, 1,5-diaminonaphthalene (DAN) and 1-nitropyrene (NP), polydimethylsiloxane (PDMS), and deoxyribonucleic acid (DNA).

Crosslinking to obtain a porous crosslinked graphene-based film may be achieved using a range of techniques. In one set of embodiments, crosslinking may be achieved by adding a suitable spacer compound to a graphene oxide solution. A porous graphene oxide film is then prepared from the solution. The spacer compound interacts with graphene oxide sheets present in the graphene oxide solution by covalent or non-covalent bonding interactions and becomes arranged in between sheets of graphene oxide during formation of the graphene oxide film. The resulting porous graphene oxide film is then crosslinked by the spacer. The crosslinked graphene oxide film may then be subsequently subjected to a reduction process, as described below.

In other embodiments, the spacer compound may be dispersed in the porous graphene oxide film but does not yet crosslink the film. Rather, chemical bonding interactions resulting in crosslinking of the film do not take place until the film is subjected to a reduction process, such as a photo-reduction process, as described herein. In one exemplary embodiment, a porous graphene oxide film comprising a spacer compound is irradiated by a beam of light or radiation and during the irradiation step, the film is crosslinked by the spacer and at least one oxygen containing functional group is also reduced. Thus crosslinking and reduction occur simultaneously, allowing simplified (i.e., one-step) fabrication of a porous crosslinked graphene-based film with selected properties.

Crosslinking may proceed under suitable conditions. In one set of embodiments, crosslinking is facilitated by the application of heat.

In some embodiments, when the porous graphene oxide film is subjected to a photo-reduction process, heat generated by a beam of light or radiation used for the photo-reduction may be sufficient to facilitate crosslinking.

In some embodiments, a porous crosslinked graphene oxide film may be prepared by layer-by-layer (LbL) self-assembly of alternating layers of a spacer material and suitable graphene oxide sheets. Thus in one set of embodiments, formation of a porous crosslinked graphene oxide film involves subjecting the graphene oxide solution to a self-assembly process. A self-assembly process may enable a porous graphene oxide film of controlled thickness to be prepared.

A self-assembly process for the formation of a porous graphene oxide film may comprise the following steps:

(1) providing a negatively charged surface;
(2) depositing a layer of positively charged material onto the negatively charged surface to form a positively charged surface; and
(3) depositing a layer of negatively charged graphene oxide sheets onto the positively charged surface.

The negatively charged graphene oxide layer may provide a negatively charged surface on to which another layer of positively charged material may be subsequently deposited. The alternating layers of positive charged and negative charged material are bound to each other via electrostatic interactions.

A porous graphene oxide film formed by layer-by-layer assembly may be supported by a suitable substrate. The substrate may provide an initial charged surface on which a layer of graphene oxide or polymer may be deposited when the layer-by-layer assembly process is commenced. The resulting porous graphene oxide film is therefore bound to the underlying substrate via electrostatic interactions. Any suitable substrate may be used. In one set of embodiments, the substrate is a glass substrate.

The deposition of a layer of a positively charged material may be achieved through the use of a solution comprising an appropriately charged compound or molecule. For example, a substrate having a negatively charged surface may be immersed in a solution comprising a positively charged material, such as a positively charged compound or a positively charged polymer. This leads to deposition of a layer of the positively charged material onto the negatively charged surface and the formation of a positively charged surface.

Following deposition of the positively charged material, a layer of negatively charged graphene oxide is then deposited onto the positively charged surface. Deposition of the negatively charged graphene oxide layer may be achieved through the use of a graphene oxide solution as described herein. For example, a substrate having a positively charged polymer-modified surface may be immersed in a graphene oxide solution comprising sheets of a negatively charged graphene oxide. This leads to deposition of a layer of graphene oxide onto the positively charged surface and the formation of a negatively charged graphene oxide surface.

The alternating deposition of layers of positively charged material and negatively charged graphene oxide may be repeated a number of times to assemble a porous graphene oxide film having layers of material interspersed in between layers of graphene oxide sheets. Each layer of material may act as a spacer to separate and space apart the layers of graphene oxide. The number of deposition steps determines the thickness of the graphene oxide film.

Pores are introduced to the self-assembled graphene oxide film through pores present in the graphene oxide material forming the graphene oxide layer that is part of the film structure.

In between each deposition step, any unattached material (e.g. unattached polymer or unattached graphene oxide) may be removed by washing the substrate-supported sample.

Once the desired number of layers has been achieved, the porous graphene oxide film may then be dried. Sample drying may be carried out with compressed air or a flow of nitrogen gas.

In one set of embodiments, positively charged material useful for the production of a porous graphene oxide film by self-assembly comprises a functional group that is capable of carrying a net positive charge at a selected pH. In one embodiment, the positively charged material may comprise a nitrogen-containing functional group that is ionised at a selected pH to form a cationic group carrying a positive charge. Nitrogen-containing functional groups present in the positively charged material may be primary, secondary or tertiary amino groups, amido groups, imino groups and the like. In some embodiments, the positively charged material may be positively charged polymer such as polyethylenimine (PEI), polydiallyldimethylammonium chloride (PDDA), poly[2-(N,N-dimethylamino)ethyl methacrylate] (PDMAEMA) and chitosan, or a positively charged compound such as chlorophyll. In one preference, the positively charged material is a positively charged polymer.

In another aspect, the present invention also provides a process for preparing a porous reduced graphene oxide film comprising the steps of:
oxidising graphite to form oxidised graphite;
exfoliating the oxidised graphite in a solvent to form a graphene oxide solution;
forming a porous graphene oxide film comprising a multilayer array of graphene oxide sheets from the graphene oxide solution; and
subjecting the graphene oxide film to a photo-reduction reduction process whereby an oxygen containing functional group situated (i) in a pore of a graphene oxide sheet and/or (ii) in between two or more graphene oxide sheets is reduced to thereby form a porous graphene-based film comprising at least one reduced graphene oxide sheet,
wherein the reduced graphene oxide sheet has a different pore size and/or is separated from a sheet that overlaps it by a different distance, relative to a corresponding graphene oxide sheet in the graphene oxide film prior to the photo-reduction step.

In one form of the above process, the porous graphene oxide film is subjected to a photo-reduction process by irradiation of the film with an appropriate source of light or radiation in a beam.

Formation of the porous graphene oxide film may be achieved by at least one film forming technique selected from filtration, spin coating, spray coating, drop casting and layer-by-layer (LbL) assembly. Such film forming techniques are described herein.

In one set of embodiments, the process further comprises the step of crosslinking the graphene oxide sheets. Crosslinking of the sheets may occur prior to, during, or after the reduction process. Crosslinking may be facilitated by use of a spacer compound as described herein.

### Reduction Process

The process of the invention involves a step of subjecting the porous graphene oxide film to a reduction process to reduce at least one oxygen containing functional group that is present in the graphene oxide film.

The reduction process can reduce one or more oxygen containing functional groups present in one or more GO sheets within the porous GO film. In some embodiments, the reduction process reduces at least one oxygen containing functional group in a plurality of GO sheets.

During the reduction process of the embodiments, an oxygen containing functional group situated (i) in a pore of a graphene oxide sheet and/or (ii) in between two or more graphene oxide sheets is reduced.

The reduction process may therefore reduce an oxygen containing functional group situated either in a pore of a graphene oxide sheet or in between graphene oxide sheets.

Alternatively, the reduction process reduces oxygen containing functional groups present both in a pore of a graphene oxide sheet and in between graphene oxide sheets.

The reduction of an oxygen containing functional group removes that functional group from a graphene oxide sheet and results in the formation of a reduced graphene oxide (rGO) sheet.

Following the reduction process, a porous graphene-based film is produced. The porous graphene-based film comprises at least one reduced graphene oxide sheet and may comprise a plurality of reduced graphene oxide sheets. A reduced graphene oxide sheet is formed when at least one oxygen containing functional group in a graphene oxide sheet is reduced and removed.

It would be appreciated by a skilled person that it is not essential to the embodiments that all the graphene oxide sheets in the porous graphene oxide film be reduced. However, the process of the embodiments provides that at least one of the graphene oxide sheets in the film is reduced.

In some embodiments, a portion of the graphene oxide sheets in the porous graphene oxide film are reduced. In such embodiments, the resultant film comprises a mixture of graphene oxide sheets and reduced graphene oxide sheets. The resultant film may therefore be a partially reduced graphene oxide film. However, such partially reduced films are still regarded as graphene-based films in accordance with embodiments described herein. A porous graphene-based films comprising at least one reduced graphene oxide sheet may also be referred to herein as a “porous reduced graphene oxide film”.

In some embodiments, each of the graphene oxide sheets in the graphene oxide film is reduced.

Reduced graphene oxide sheets present in a porous graphene-based film are also part of a multilayer array.

A skilled person would understand that the reduction process conditions can be adjusted so as to vary the amount of oxygen containing functional groups that are reduced and thus alter the degree or extent of reduction. As explained further below, changes in the degree of reduction can enable the sieving properties of the porous graphene-based film to be adjusted.

In some embodiments the process may selectively reduce an oxygen containing functional group that is located in a pore or in an interlayer space of the porous graphene oxide film. The selectivity may be possible as the type of oxygen containing functional groups present in a pore may be different from that in an interlayer space. For instance, a porous graphene oxide film as described herein may comprise hydroxyl and epoxy functional groups attached to the basal plane of a graphene oxide sheet, which extend into the interlayer space in between graphene oxide sheets. Meanwhile, carbonyl and carboxyl functional groups may be attached to a defect edge of a graphene oxide sheet and thus such functional groups may be present in a pore of the graphene oxide sheet.

Reduction processes described herein may be capable of distinguishing between different types of oxygen containing functional groups and thus the process of embodiments described herein may be able to selectively reduce different oxygen containing functional groups that are positioned at different locations in a graphene oxide film.

The reduction of an oxygen containing functional group in accordance with the process of the embodiments results in the removal of that oxygen containing functional group and spa carbon atoms from the graphene oxide sheet and the formation of more hydrophobic graphene domains.

The reduction of an oxygen containing functional group that is situated in a pore of a graphene oxide sheet results in a change in the size of the pore. This change in pore size occurs due to the removal of the oxygen containing functional group by the reduction process. In one set of embodiments, the pore size (determined as pore diameter) of a reduced graphene oxide sheet is increased, in comparison to the original pore size in the corresponding graphene oxide sheet.

The reduction of an oxygen containing functional group that is situated in between graphene oxide sheets produces in a change in the separation distance or interlayer spacing between the sheets, as the oxygen containing functional group is removed from the basal plane of a graphene oxide sheet. The reduced graphene oxide sheet that is formed after the reduction step is therefore separated from a graphene-based sheet (which may be a graphene oxide sheet or another reduced graphene oxide sheet) that overlaps it by a different distance, compared to the original corresponding graphene oxide sheets in the graphene oxide film prior to the reduction process. In one set of embodiments, the separation distance between a reduced graphene oxide sheet and a sheet overlapping it is reduced (i.e. smaller).

Any change in the pore size and/or the sheet separation distance is determined by comparison to a corresponding graphene oxide sheet that is present in the porous graphene oxide film prior to the reduction process. A “corresponding” graphene oxide sheet is thus related to a selected reduced graphene oxide sheet in that it is positioned at the same location as that reduced graphene oxide sheet within the multilayer array. Thus the corresponding graphene oxide sheet is the original, oxidised graphene sheet prior to it being subjected to the reduction process.

Accordingly, a selected pore in a reduced graphene oxide sheet will be compared to a corresponding pore in the graphene oxide sheet prior to the reduction process being performed, and any change in pore size (diameter) following reduction will be ascertained relative to the size of the original pore in the graphene oxide sheet.

Similarly, the separation distance between selected graphene-based sheets in a porous graphene-based film will be compared to the separation distance between corresponding graphene oxide sheets prior to the reduction process being performed, and any change in the separation distance between selected sheets following reduction will be ascertained relative to the original separation distance between equivalent sheets in the graphene oxide film.

In one set of embodiments, the porous graphene-based film comprises a plurality of reduced graphene oxide sheets, where the separation distance or interlayer spacing between the reduced graphene oxide sheets is decreased, relative to that of the corresponding graphene oxide sheets in the graphene oxide film prior to the reduction process.

Changes in the pore size and/or the separation distance produced as a result of the reduction process allow the properties of the porous graphene-based film to be adjusted. In some embodiments, the reduction process may selectively reduce oxygen containing functional groups situated in one or more pores and/or in between two or more sheets of graphene oxide to enable the pore size and/or interlayer spacing to be controlled. Changes in pore size and/or interlayer distance induced by the reduction and removal of oxygen containing groups can alter the sieving capabilities of the resultant porous graphene-based film.

Reduction of the porous graphene oxide film may be performed under suitable conditions. In one set of embodiments the reduction process may involve thermal reduction, chemical reduction or photo-reduction of oxygen containing functional groups, and mixtures of these reduction processes. In a particular embodiment, the reduction process involves photo-reduction of oxygen containing functional groups.

Thermal reduction of the porous graphene oxide film may involve heating the film to a suitable temperature in order to reduce at least one oxygen containing functional group. In one set of embodiments, the porous graphene oxide film may be heated to a temperature up to 1100° C. In one set of embodiments, the porous graphene oxide film may be heated at a temperature in a range of from about 80° C. to about 1100° C. During thermal reduction, the bonds that connect the oxygen containing functional groups to the graphene basal plane break, resulting in the generation of H₂O, CO₂ and CO gases. It can be preferable for the temperature to not exceed 1100° C. as above this temperature, C—C bonds in the graphene network can break to introduce defects in the graphene basal plane. The applied thermal energy can be varied to vary the extent of reduction and thus the pore size and/or the interlayer spacing of the reduced graphene oxide film. For instance, higher temperatures and/or longer heating times may produce larger pores and/or a smaller interlayer spacing in the resultant porous reduced graphene oxide film. In some embodiments, thermal reduction may be performed in a substantially oxygen-free environment (such in a vacuum or an inert atmosphere) to reduce the incidence of undesirable defects or damage being introduced to the basal graphene sheet.

Chemical reduction of the porous graphene oxide film may be carried out with the aid of chemical agents or other chemical processes that remove at least one oxygen containing functional group. In one form of the process of the invention, the porous graphene oxide film is reduced by treating the graphene oxide film with a chemical agent. The chemical agent may be selected from those conventionally used in the art. Such chemical agents include but are not limited to hydrazine, alcohol, sodium borohydride, c with acetic acid, alkali metal hydroxide (such a sodium hydroxide and potassium hydroxide), metal powder (iron or aluminium powder), ammonia, hexylamine, sulphur-containing compounds (NaHSO₃, Na₂SO₃, Na₂S₂O₄, Na₂S₂O₃, Na₂S.9H₂O, SOCl₂, and SO₂), hydroxylamine hydrochloride, urea, lysozyme, vitamin C, N-methyl-2-pyrrolidinone, poly(norepinephrine), bovine serum albumin (BSA), TiO₂ nanoparticles, manganese oxide and bacteria respiration. The type of chemical reductant employed and time during which the graphene oxide film is treated with chemical reductant can dictate the pore size and interlayer spacing in the resultant porous reduced graphene oxide film.

Photo-reduction of the porous graphene oxide film may involve irradiation of the film with a suitable source of light or radiation in a beam. The irradiation may induce a thermal (i.e. photo-thermal) or chemical (i.e. photo-chemical) effect, which reduces at least one oxygen containing functional group present in the porous graphene oxide film. The photo-reduction includes photo-reduction of the oxygen containing functional groups by irradiation of the graphene oxide film with the beam of the light or radiation.

By irradiation, oxygen containing functional groups may be removed and hydrophobic graphene domains may be formed. Thus the process of the invention described herein can involve irradiating the porous GO film with a beam of light or radiation to reduce one or more oxygen containing functional groups in the GO film, to thereby form a porous graphene-based film comprising at least one reduced graphene oxide (rGO) sheet. In some embodiments, the porous graphene-based film formed after irradiation may comprise a plurality of reduced graphene oxide (rGO) sheets.

Photo-thermal reduction may involve the use of the light or radiation to irradiate the porous graphene oxide film and generate localized heat in the film. The heat that is generated following irradiation depends on the source of the light or radiation and thermal properties of the graphene oxide film. Parameters such as the wavelength and/or intensity of the source and the time (i.e. duration) of irradiation can influence the pore size and/or the interlayer spacing of the porous graphene-based film formed after reduction due to the amount of thermal energy (or heat) that is generated. In one embodiment, photo-thermal reduction is performed in a substantially oxygen-free environment, such as in a vacuum or in an inert atmosphere such as a nitrogen or argon atmosphere. In photo-thermal reduction, the light or radiation can include different forms of electromagnetic radiation, including optical radiation.

Photo-thermal reduction may be performed using light or radiation of any suitable wavelength. Suitable wavelengths may vary from the UV range (approximately 10 to 400 nm) up to the infrared range (approximately 700 nm to 1000 μm). Suitable wavelengths may be emitted by a laser, such as such as an ultraviolet (UV) or infrared (IR) laser.

In some embodiments, suitable wavelengths may be from approximately 248 nm up to 10.6 μm from a CO₂ laser.

Photo-thermal reduction may be performed using any suitable type of light or radiation source. A suitable light or radiation source preferably has sufficient power to generate a minimum amount of heat. In some embodiments, a suitable light or radiation source has sufficient power to heat the porous graphene oxide film to a temperature of at least about 200° C. during the reduction process. Some examples of light sources that may be used facilitate photo-thermal reduction include but are not limited to UV lamps, focused sunlight and flash lights.

Photo-thermal reduction of the porous graphene oxide film can involve irradiation of the graphene oxide film with a beam of light or radiation with sufficient irradiance to generate the minimum amount of heat. A suitable spot size can be selected based on the radiant power of the source of the light or radiation—i.e., the provided light or radiation source—to provide sufficient radiant flux (power) at the surface per unit area, i.e., sufficient “irradiance”, measured in Watts per square metre (W/m2). Thus, the higher the source power, the larger the treated surface area can be. For a femtosecond laser, the selected average power can be in the range of 1 to 1000 micro-Watts (μW). For a continuous-wave (CW) laser, the selected average power can be in the range of from few to several hundred milli-Watts (mW), preferably in the range of from 5 to 100 milli-Watts (mW) or from 10 to 100 milli-Watts (mW). For a UV lamp or other light source, the selected power output can be in the range of 100 to 1000 Watts, such as for example, a power output of about 100 W. The source can include pulsed sources (including pulsed lasers, and camera flashes) and CW sources (including sunlight, UV lamps, and laser diodes).

In some embodiments, photo-thermal reduction may advantageously permit the controlled removal of oxygen functional groups by adjusting the power of the source of light or radiation. Different powers can be used to generate different temperatures. In turn, as different oxygen containing functional groups may have different binding energies, different oxygen containing functional groups may dissociate at different temperatures, allowing particular oxygen containing functional groups to be selectively removed.

Photo-chemical reduction uses a shaped pulse of light or radiation to control chemical reactions that occur during the reduction of the porous graphene oxide film. Thus light or radiation may facilitate the chemical reduction of one or more oxygen containing functional groups in the graphene oxide film. In some embodiments, it may be possible to control the pore size and/or the interlayer spacing of a porous graphene-based film by selectively removing certain oxygen containing functional groups that are situated in the pores of graphene oxide sheets and/or in between graphene oxide sheets. The selective removal of an oxygen containing functional group may be facilitated by the use of a shaped pulse of light or radiation.

A shaped pulse, such as a shaped light pulse, may be provided by a suitable source of light or radiation. In some embodiments, a shaped pulse may be provided from a femtosecond laser. Any suitable femtosecond laser can be used. Furthermore, any suitable spot size can be used. The spot size depends on the laser power and the average power of the laser depends on the repetition rate of the laser pulses (for 1 kHz it requires several tens of μW and for 80 MHz it requires several mW).

In some embodiments, the selective reduction of oxygen containing functional groups may be manipulated by changing the pulse shape. In such embodiments, the pulse shape can be iteratively updated by a feedback loop taking input from an in-situ monitoring method, such as Raman spectroscopy or Fourier transform infrared (FTIR) spectroscopy. In some embodiments, the selective reduction of oxygen containing functional groups may be manipulated by changing the pulse width.

When spacers or crosslinks are present, the interlayer spacing of the porous graphene-based film may be influenced by both the size of the spacers or crosslinks and whether the spacers or crosslinks are removed by the reduction process.

Photo-reduction by irradiation with a beam of light or radiation may be advantageous as it provides the ability to accurately control the reduction process and hence the pore size and interlayer spacing in the porous graphene-based film. For instance, reduction of an oxygen containing functional group in a pore of a graphene oxide sheet and/or in between two or more graphene oxide sheets may be selectively controlled by adjusting the radiation power. In some embodiments, the higher the power of the beam, the higher the proportion of oxygen containing functional groups in the graphene oxide film that are reduced. In one set of embodiments, photo-reduction may be carried out by irradiation of the porous graphene oxide film with a laser beam working at a power in the range of from 5 mW to 50 mW.

The ability to control the reduction process through irradiation of the porous graphene oxide film using a controlled beam enables porous graphene-based films having different pore sizes and/or interlayer spacing in different regions of the film to be produced. Accordingly, it is possible to tune the properties of the porous graphene-based film to suit a desired application by controlling the power of the beam to adjust the pore size and/or interlayer spacing with high precision in the sub-nanometer region.

The use of a photo-reduction technique to reduce oxygen containing functional groups in a porous graphene oxide film may be advantageous as the type and coverage of oxygen containing functional groups in the film can be manipulated by adjusting irradiation parameters (including wavelength, power, and exposure time) of the light source. Consequently, the surface properties of the porous graphene oxide films can be selectively controlled to suit different applications.

For example, when light or radiation of short wavelength is used for irradiation, the power can be reduced due to higher photon energy. Furthermore, for a given wavelength and power of light or radiation, an increase in exposure time can increase the number of oxygen containing functional groups being removed and thus increase the extent by which the graphene oxide film is reduced. Additionally, for a shaped light pulse, the repetition rate, pulse width and pulse shape may also influence the extent of reduction.

For a given source of radiation, the operating power range can be ascertained by scanning the power. The lower power threshold (i.e. the reduction threshold) of a beam can be determined by observing a transmission change under an optical microscope. The upper power threshold (i.e. the ablation/burning threshold) of a beam can be ascertained by visually observing when ablation occurs. This may be done by using a microscope. The upper and lower thresholds can dictate the operating range of power in which irradiation can be performed. Selective oxygen containing functional group removal can be achieved by controlling the power of the beam within the operating range.

The porous graphene oxide film is irradiated at least once, and may be irradiated multiple times, in order to reduce the oxygen containing functional groups in the film. Multiple irradiations may result in the removal of an increasing number of oxygen containing functional groups in the film.

The irradiation affords the ability to locally reduce oxygen containing functional groups in at least one selected area or zone of the porous graphene oxide film. Thus, it may be possible to form a patterned film comprising selected areas or zones of graphene oxide and reduced graphene oxide for specific applications.

For instance, patterning with an irradiation process can be achieved by laser patterning or photo-illumination, which can be facilitated with a mask. The mask can cover a defined area of a porous graphene oxide film and may help to direct or control how light or radiation reaches that area of the film. This in turn may help to control how oxygen containing functional groups are reduced in that particular area of the film. In this manner, a porous graphene-based film having different localised areas with different degrees of reduction can be formed. Such a patterned graphene-based film may be advantageous as it can enable the fabrication of filters having multiple integrated regions or zones with different sieving capabilities in the different regions or zones. Such porous multi-zone graphene-based films can therefore provide selective and multi-functional sieving capabilities in a single film.

It is one advantage that photo-reduction of the porous GO film by irradiation of the film with a beam of light or radiation can enable selected regions or zones of the GO film to be selectively reduced.

In one embodiment of the process of the invention, a selected zone of the porous graphene oxide film is irradiated by a laser beam to reduce an oxygen containing functional group situated (i) in a pore of a graphene oxide sheet and/or (ii) in between two or more graphene oxide sheets in the selected zone and thereby alter the pore size and/or sheet interlayer distance in the selected zone by forming at least one reduced graphene oxide sheet in the selected zone. The irradiated selected zone may be of different porosity than at least one other zone of the film.

In one embodiment, the process of the invention comprises the step of irradiating a selected zone of the porous graphene oxide film while another selected zone of the porous graphene oxide film is not irradiated, to thereby form a porous multi-zone graphene-based film comprising a graphene oxide zone and a reduced graphene oxide zone. The reduced graphene oxide zone in the multi-zone graphene-based film has been subjected to a photo-reduction process and thereby comprises at least one porous reduced graphene oxide film as a result of the reduction process. The graphene oxide zone of the multi-zone graphene-based film comprises porous graphene oxide that has not been reduced.

In another embodiment, the process of the invention comprises the steps of irradiating a first selected zone of the porous graphene oxide film under a first condition and irradiating a second selected zone of the porous graphene oxide film under a second condition to thereby form a porous multi-zone graphene-based film comprising at least two different zones of different porosity. The different porosity in the different irradiated zones are provided by the zones comprising reduced graphene oxide sheets having a different pore size and/or being separated from a sheet overlapping it by a different interlayer distance. Porous graphene-based films comprising two different irradiated zones are also considered to be multi-zone graphene-based films.

The ability to control the reduction process through irradiation of the porous graphene oxide film using a controlled beam enables porous graphene-based films having different pore sizes and/or interlayer spacing in different regions or zones of the film to be produced. Thus for example, the interlayer spacing in a first zone of the film may be different from the interlayer spacing in a second zone of the film. In other words, the interlayer spacing in the first zone may be larger or smaller than that in the second zone.

Accordingly, it is possible to tune the properties of the porous graphene-based film to suit a desired application by controlling the properties of beam to adjust the pore size and/or interlayer spacing with high precision in the sub-nanometer region.

In one embodiment it is possible to vary the extent of reduction in a selected zone of the porous graphene oxide film by varying the varying the power of a laser beam used to irradiate the graphene oxide film. A laser beam working at variable power provides the ability to reduce oxygen containing functional groups in different zones in a porous graphene oxide film to different extents. For example, it has been found that an increase in laser power can result in smaller interlayer separation distances being produced. Accordingly, the irradiation of different zones of a porous graphene oxide film by a laser working at different powers provides the possibility of being able to tune the interlayer distance between graphene-based sheets in the different irradiated zones. Different zones in the graphene-based film having different interlayer spacing may differ in colour (i.e. be darker or lighter in colour) and thus might readily be visually discerned.

In some embodiments, where a porous graphene oxide film comprises a spacer compound, irradiation of a selected zone of the graphene oxide film to subject the film to photo-reduction can result in simultaneous crosslinking and reduction of the film in the selected zone. Thus the resulting graphene-based film comprises a zone that is crosslinked and which also comprises at least one reduced graphene oxide sheet.

The beam of light or radiation may also be able to selectively remove carbon atoms from a graphene-based sheet (which may be a graphene oxide sheet or a reduced graphene oxide sheet) by selectively breaking carbon-carbon bonds and removing sp3 carbon atoms in the graphene basal plane of the sheet, such as a graphene oxide (GO) or reduced graphene oxide (rGO) sheet. In this manner, additional pores may be generated in the porous graphene-based film. Such openings created in the basal plane of the sheet by breaking carbon-carbon bonds may be regarded as defect openings. The irradiation parameters may be chosen to selectively generate one or more defect openings in the plane of the sheet. This can therefore provide a further avenue for tailoring the porosity of the porous graphene-based film.

Defect openings formed in the plane of a sheet may have a diameter ranging in size from several nanometers to hundreds of nanometers. The defect openings may be created by irradiating the graphene-based film with a suitable laser during the reduction process. A range of suitable lasers may be used. Some examples of suitable lasers for generating defect openings include UV lasers and red lasers. Such lasers are usually operated at higher operating conditions (e.g. higher laser power) than that employed for the photo-reduction step, to create the defect openings in the graphene-based films.

Moreover, the reduction process can be combined with a graphene oxide film synthesis technique that controls the properties of the interlayer space, providing a larger tuning range for the interlayer spacing. Thus the interlayer spacing may be tuned within a distance ranging from tens of nanometres down to sub-nanometres. Accordingly, the process of embodiments described herein may provide porous graphene-based films having a range of versatile properties.

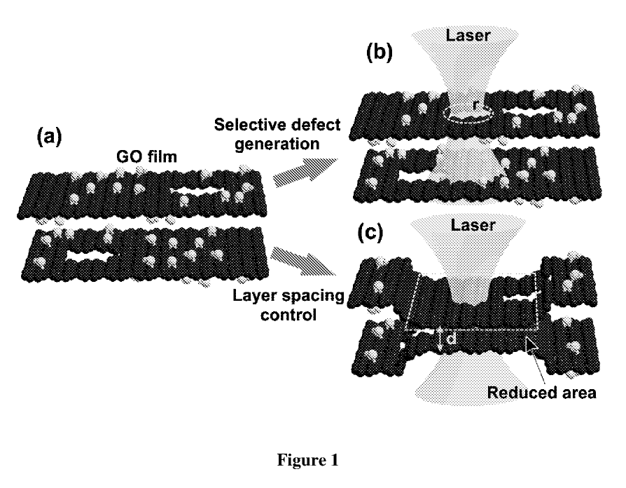

A schematic diagram illustrating a process for preparing a porous graphene-based film in accordance with one or more embodiments of the present invention is shown in FIG. 1. Illustrated in FIG. 1(a) is a schematic of bilayer of graphene oxide (GO) sheets within a porous graphene oxide film. The GO sheets have oxygen containing functional groups attached to both sides of each sheet. A tightly focussed laser beam can be used to selectively reduce oxygen containing functional groups in a pore of a GO sheet, or to generate selective defects in a GO sheet, as shown in FIG. 1(b). The interlayer spacing or separation distance (d) between the sheets can also be controlled by reducing oxygen containing functional groups that extend from the basal plane of the GO sheet and are present in between the sheets, as shown in FIG. 1(c).

Embodiments of the process described herein may allow selective alteration of the size of one or more pores in a selected graphene oxide sheet. This can enable the generation of porous graphene-based film having pores tailored with diameters ranging from 1 and 1000 nm within the plane of a rGO sheet following the reduction step.

Additionally, or alternatively, embodiments of the process described herein may allow selective alteration of the interlayer spacing that separates sheets within the porous graphene-based film. This can enable sheets in the porous graphene-based film to be separated from one another by a wide range distances, ranging from 3 to 9 Angstroms (Å).

To enable photo-reduction of oxygen containing functional groups by irradiation, the porous GO film may be attached to a three-dimensional (3D) surface. An emitting device is used as the radiation source, which can be a laser emitting device or laser. For example, the emitting device may be a laser, including a laser diode or a femtosecond laser source. The emitting device may be mounted on a movement control device to form a movable emitting system (which may be referred to as a “laser 3D printer”), in which the 2D and/or 3D position of the emitting device and the beam are controllable and adjustable.

A focussing element, which can be an objective lens, may also be used to focus the laser beam on the 3D surface to which the porous GO film is attached. The focussing element may be connected to the emitting device and/or the movement control device, so as it may move together with the emitting device. The objective lens may be conventional objective lens that can be used to focus a beam of light or radiation. The focussing element may also be part of a commercially available emitting device package, e.g., a laser or a light that has a focusing lens. In some other embodiments, the emitted laser may be directly used for the reduction, without using the focussing element, which can be used for large area reduction.

The beam of light or radiation may be movable relative to the porous GO film during the irradiation, thereby allowing reduction of the GO film according to a selected pattern. The selected pattern may be any suitable 2D or 3D pattern. The movement of the beam may be controlled manually. Alternatively, the movement of the beam may be controlled automatically, e.g., by running a pre-programmed controlling program based on the selected pattern.

The emitting device may include a 3D surface detecting unit that automatically detects a 3D surface, which may allow the porous GO film to be attached to an arbitrary surface, e.g., surface with an arbitrary 2D/3D shape or structure.

### 3D Films

In one set of embodiments, when the porous graphene oxide film is irradiated to subject the film to a photo-reduction process, gases may be generated in situ during the reduction of one or more oxygen containing functional groups. In this process, gases, such as CO, CO₂ and H₂O vapour, may be generated due to the removal of oxygen functional groups and the water between the plurality of layers of GO sheets. During the irradiation, the gases may be heated up in a high speed, which may result in expansion of the volume of the gases, thus modifying the orientation of one or more sheets in the film and thereby forming a graphene-based film having a porous 3D structure. Porous graphene-based films having a 3D may also be referred to as “3D films”.

In form of the process, the photo-reduction step involves irradiating the porous graphene oxide film with a CO₂ laser working at about 100 mW power. Irradiation of the graphene oxide film under such conditions may generate a porous graphene-based film having a 3D structure.

In one set of embodiments, when the graphene-based film has a 3D structure, there may be a further step of irradiating the 3D graphene-based film with a laser beam to form one or more passages extending through the 3D film. In this manner, further openings may be created in the 3D film. An exemplary laser beam for forming one or more passages in the 3D film may be emitted by a CO₂ laser working at about 100 mW. Such a laser operating at such a power may be capable of simultaneously reducing the film and generating passages in the film.

Passages formed in a 3D graphene-based film may be much larger than the pores or defect openings in the graphene-based sheets of the 3D film. For example, passages in the 3D film may have a diameter ranging in size from several nanometers (nm) to micron (μm).

### Graphene-Based Films

The present invention also provides a porous graphene-based film prepared by the process of any one of the embodiments described herein.

Porous graphene-based films produced herein may advantageously have a narrow pore size distribution and/or interlayer spacing distribution due to the ability to precisely control the reduction of oxygen containing functional groups in selected areas of the film.

In some embodiments, a narrow distribution may mean that the pore size and/or interlayer spacing varies by no more than 10% from the mean value.

Porous graphene-based films prepared in accordance with the invention may be used in a range of applications. In particular, the porous reduced graphene-based films may desirably be used in applications where well-defined porosity or molecular sieving capabilities are required.

In particular embodiments, porous graphene-based films prepared in accordance with the invention may suitably be used in filtration applications. Thus, the porous graphene-based films may be fabricated as filtration membranes.

Porous graphene-based films produced by the process of the invention may advantageously be quite thin, with a thickness in the nanometre range. In some embodiments, the porous graphene-based films may have a thickness of in a range of from about 30 nm to about 3 μm. The thickness of the porous graphene-based film can be readily varied to suit a particular application. For example, for filtration applications it may be desired for the porous graphene-based film to have a thickness in the range of from about 30 nm to 300 nm.

In another aspect, the present invention provides a porous multi-zone graphene-based film comprising a reduced graphene oxide zone comprising porous reduced graphene oxide, and at least other zone comprising porous graphene oxide or porous reduced graphene oxide, wherein the at least one other zone is of a different porosity than the reduced graphene oxide zone.

The reduced graphene oxide zone of the multi-zone film is formed by subjecting a selected zone of a porous graphene oxide film to a photo-reduction process as described herein, whereby at least one oxygen containing functional group situated in (i) a pore of a graphene oxide sheet and/or (ii) in between two or more graphene oxide sheets is reduced, to thereby form reduced graphene oxide in the selected zone. The reduction of the oxygen containing functional group alters porosity by altering the pore size and/or interlayer separation distance of sheets in the reduced graphene oxide zone.

In one set of embodiments, the reduction process involves photo-reduction by irradiation of the selected zone by light or radiation as a beam, as described herein.

The porous multi-zone graphene oxide film also comprises at least one other zone. The other zone may be either a graphene oxide zone that comprises porous graphene oxide, or it may be another reduced graphene oxide zone comprising porous reduced graphene. When the other zone is a reduced graphene oxide zone, it will be appreciated that the zone would have a different porosity.

In one form, when the porous multi-zone graphene-based film comprises a reduced graphene oxide zone and at least one other zone (which may be selected from a graphene oxide zone or a reduced graphene oxide zone) of different porosity, the different porosity between the zones may be provided by pores in one or more sheets of the rGO zone being of a different size than that of pores in the other zone.

In another form, when the porous multi-zone graphene-based film comprises a reduced graphene oxide zone and at least one other zone (which may be selected from a graphene oxide zone or a reduced graphene oxide zone) of different porosity, the different porosity between the zones may be provided by sheets in the rGO zone being separated by an interlayer spacing that is different than that of sheets in the other zone.

The other zone may be either a graphene oxide zone that comprises porous graphene oxide, or it may be another reduced graphene oxide zone comprising porous reduced graphene.

In one set of embodiments there is provided a porous multi-zone graphene-based film comprising a reduced graphene oxide zone comprising porous reduced graphene oxide, and a graphene oxide zone comprising porous graphene oxide, wherein the graphene oxide zone is of a different porosity than the reduced graphene oxide zone. The different porosity may be due to the presence of a different pore size and/or different interlayer spacing in the different zones, as described herein. It would be appreciated that the graphene oxide zone has not been subjected to a reduction process to reduce an oxygen containing functional group as described herein.

In another set of embodiments there is provided a porous multi-zone graphene-based film comprising at least two different reduced graphene oxide zones, wherein the two different reduced graphene oxide zones have a different porosity to one another. The different rGO zones may be produced by irradiating the different selected zones under different conditions, which result in different extents of oxygen containing functional group reduction and hence different porosity in the different zones.

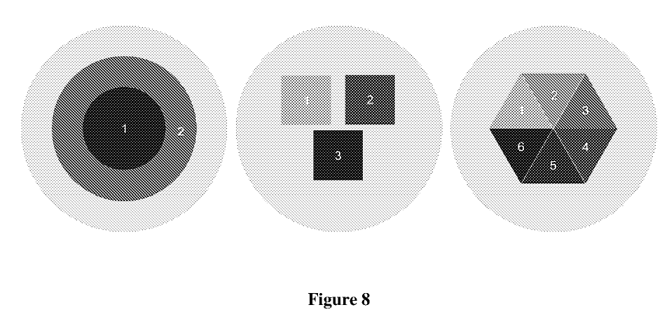

Irradiation of the GO film to form a porous multi-zone graphene-based film may proceed in a defined manner so as to produce a selected multi-zone pattern comprising one or more rGO zones in different areas of the film. Some examples of patterns that may be produced are illustrated in FIG. 8.

In one form, when the porous multi-zone graphene-based film comprises at least two different reduced graphene oxide zones, the different porosity in the different rGO zones may be provided by pores in one or more sheets of a rGO zone being of a different size than that of pores in another rGO zone.

In another form, when the porous multi-zone graphene-based film comprises at least two different reduced graphene oxide zones, the different porosity in the different rGO zones may be provided by sheets of a rGO zone being separated by an interlayer spacing that is different than that of sheets in another rGO zone.

In some embodiments, the porous multi-zone graphene based film described herein may be crosslinked. Crosslinking may be achieved by use of techniques and an appropriate spacer as described herein.

In some embodiments, graphene-based films as described herein may comprise defect openings in one or more sheets of the film. In a porous multi-zone graphene-based film comprising at least two different reduced graphene oxide zones, wherein each of the different reduced graphene oxide (rGO) zones may comprise at least one reduced graphene oxide sheet with one or more defect openings in the plane of the sheet. In such embodiments, defect openings present in one reduced graphene oxide zone may be of a different size to the defect openings present in the other reduced graphene oxide zone. The defect openings may be formed by procedures described herein.

The porous multi-zone graphene-based film described herein may be in the form of a 3D film having a 3D structure comprising multiple zones of different porosity, which is capable of being tuned. Procedures for forming 3D structures from 2D graphene-based films are described herein.

In one set of embodiments, a 3D multi-zone graphene-based film may comprise one or more passages extending through the 3D film. In such embodiments, the 3D multi-zone film may comprise at least two different reduced graphene oxide zones, wherein each of the different reduced graphene oxide zones comprise one or more passages extending through the zone, and wherein said passages in the different reduced graphene oxide zones are of a different size to one another. The passages may be formed by procedures described herein.

### Filtration Membranes

In another aspect the present invention provides a filtration membrane comprising a porous graphene-based film prepared by the process of any one of the embodiments described herein.

Filtration membranes comprising porous graphene-based films of the present invention have effective sieving capabilities as the porous graphene-based film permits the passage of molecular species having a size that is at or below that of the size of the pores and the channels defined by the interlayer spacing in the film, while blocking the passage of larger size species that are not able to pass through the pores or channels. In some embodiments, graphene-based sheets in the porous graphene-based film may be spaced apart by a distance in the nanometer range. Thus the interlayer spacing between the graphene-based sheets may define nanochannels within the porous graphene-based film.

In some embodiments, filtration membranes comprising a porous graphene-based film of the present invention may be exhibit a molecular weight cut-off in a range of from approximately 100 to 500 Da. Accordingly, membranes comprising a porous graphene-based film may be useful as desalination membranes or nanofiltration membranes.

In addition to the being able to alter pore size and interlayer spacing by reducing oxygen containing functional groups, the sieving capability of a filtration membrane (and hence its molecular weight cut-off) may also be modified through the inclusion of a spacer in the porous graphene-based film. The presence of a spacer may help to increase the interlayer spacing in the porous graphene-based film and thus may increase the molecular weight cut-off of the resulting membrane.

The hydrophilic or hydrophobic properties of the filtration membrane may also be controlled by the relative quantities of graphene oxide (GO) sheets and reduced graphene oxide (rGO) sheets in the porous graphene-based film. In the porous graphene-based film, water molecules can permeate through interconnected nanochannels formed between the sheets and follow a path primarily over the surface of the sheets. Reduced graphene oxide sheets in the porous graphene-based film have a hydrophobic surface due to the graphene structural domains. These hydrophobic areas can provide a nearly frictionless surface that facilitates the fast flow of water molecules through the film and the filtration membrane. A lower ratio of graphene oxide sheets to reduced graphene oxide sheets may produce a porous graphene-based film with greater hydrophobicity.

A filtration membrane may comprise a substrate and a porous graphene-based film as described herein on the substrate. The substrate may support the porous graphene-based film. Any suitable substrate may be used. The substrate is preferably porous and is of greater porosity than the porous graphene-based film. In one set of embodiments, the substrate may be porous polymer substrate comprising a suitable polymer. An exemplary polymer substrate comprises polyethersulfone (PES).

In one set of embodiments, it is preferable that the porous graphene-based film adheres to the substrate. This can assist with maintaining the strength and other physical properties of the filtration membrane, thus helping to ensure the membrane retains structural integrity during its practical working life.

The photo-reduction process may promote interactions that assist in the bonding and adherence of the porous graphene-based film to an underlying substrate.

The present invention can enable porous graphene-based films and membranes comprising the porous graphene-based films to be prepared on a large scale. The large scale production of porous graphene-based films with tuneable sieving properties can proceed in a convenient and cost effective manner. Accordingly, the mass production of porous graphene-based films and membranes may be conveniently achieved.

Such porous graphene-based films may be useful for the selective separation of different molecular species of different size in a solution.

Furthermore, embodiments of one or more process described herein may allow simplified (e.g. one step) fabrication of a porous graphene-based membranes having selected properties, such as tailored sieving properties. For instance, processes described herein may conveniently enable the formation of porous multi-functional graphene-based films having different and tuneable pore sizes and/or interlayer spacing in different selected regions of the film, which may be useful as filtration membranes. Such membranes can be engineered to provide different molecular weight cut-offs targeted for the retention or removal of selective solutes or species in solution.

Filtration membranes comprising a porous graphene-based film according to embodiments of the present invention may be able to function as multi-channel filtering devices, which are able to separate different molecules or species of different size at the same time.

In another aspect, the present invention provides a method of removing a target solute from a solution comprising the step of filtering a solution comprising the target solute through a filtration membrane according to any one of the embodiments described herein, whereby the target solute is selectively retained by the membrane. The target solute may be retained by a pore and/or a channel in the membrane.

Processes described herein, and porous graphene-based films and membranes, such as filtration membranes, comprising porous graphene-based films prepared by such processes provide a number of advantages, including one or more of the following:
A well-defined pore size and interlayer spacing, which is able to provide for the effective separation of a targeted species by sharply cutting off species above a defined size, thus effectively blocking the passage of those species while smaller sized species can readily pass through. The present invention enables both the pore size and interlayer spacing to be precisely controlled, resulting in narrow distributions.
A large tuning range for the pore size and interlayer spacing, which allows sieving properties of the porous graphene-based films and membranes comprising the films to be adjusted within a wide range, thus providing the benefit of being able to tailor films and membranes for use in a broad spectrum of applications. Thus for an identified target species, the sieving properties of the porous graphene-based film can be adjusted to achieve a molecular cut-off that results in retention or removal of a significant quantity of the target species from a solution.
The ability to produce porous graphene-based films of controlled and tuneable pore sizes through the use of photo-reduction techniques involving irradiation by the beam of the light or radiation. Photo-reduction mediated by a beam of light or radiation can be used to tune pore sizes from the sub-nanometer range to several microns. This allows membranes comprising porous graphene-based films of the invention to be used for microfiltration, ultrafiltration, nanofiltration, and reverse osmosis.
Fast flow rates through the porous graphene-based films and membranes comprising the films, which results in high energy efficiency and a high productivity. Water molecules and species, such as ions, molecules and cells, that have sizes that are smaller than the interlayer spacing in the porous graphene-based film can permeate rapidly through the channels formed between sheets in the film and follow a path over the hydrophobic surface of reduced graphene oxide sheets with extremely fast flow rate, even when the interlayer spacing is down to sub-nanometre range, due to the nearly frictionless surface of the hydrophobic area.
Porous graphene-based films and membranes comprising the films are thermally stable and chemically inert, which allows the films and membranes to be used in applications that operate in hash environments. The porous graphene-based films and membranes are believed to have tolerance to high temperatures, oxidants, strong acidic/alkaline regents, and organic solvents.
Porous graphene-based films and membranes comprising the films have good mechanical strength, allowing the films and membranes to be used in high pressure filtration applications. The films and membranes can be used without the need to incorporate reinforcements to support the films and membranes and prevent their breakage.
The ability to produce thin porous graphene-based films and membranes, which might enable higher flow rates and reduced back-pressures to be achieved. Ultra-thin (down to tens of nanometres) films and membranes may be achieved.
The porous graphene-based films and membranes comprising the films may be manufactured economically. The porous graphene-based films can be synthesised directly from bulk graphite material with low cost oxidants and economical film fabrication techniques such as vacuum filtration, layer-by-layer (LbL) assembly, spin coating, spray coating and drop casting. Furthermore, relatively cheap reduction processes may be employed. The process of the invention may be used to readily produce graphene-based films on a laboratory scale or an industrial scale.
Membranes comprising porous graphene-based films of the invention may have low running costs and maintenance cost. Membranes comprising the porous graphene-based films do not require high pressure working conditions due to the high flow rates possible with the films. Thus, filtration systems employing the membranes are energy efficient and require low running costs. Moreover, since the porous graphene-based films have good mechanical strength and thermal and chemical stability, the life time of the films and membranes comprising the films is significantly longer than that of conventional membranes, such as polymer membranes. Furthermore, the surface properties of the reduced graphene oxide sheets in the films may help to inhibit unwanted fouling of the films and membranes. As a result, the porous graphene-based film and membranes comprising the films do not require frequent maintenance or replacement, which can in turn reduce the overall cost of a filtration process.
The porous graphene-based oxide films can be prepared in an environmentally friendly manner, employing environmentally friendly solvent. Furthermore, the porous graphene-based films are non-toxic and compatible with biological samples.

The invention will now be described with reference to the following examples. However, it is to be understood that the examples are provided by way of illustration of the invention and that they are in no way limiting to the scope of the invention.

### EXAMPLES

### Preparation of Graphene Oxide Solution:

The natural graphite powder (SP-1, Bay Carbon) (20 g) was put into an 80° C. solution of concentrated H₂SO₄ (30 mL), K₂S₂O₈ (10 g), and P₂O₅ (10 g). The resultant dark blue mixture was thermally isolated and allowed to cool to room temperature over a period of 6 hours. The mixture was then carefully diluted with distilled water, filtered, and washed on the filter until the rinse water pH became neutral. The product was dried in air at ambient temperature overnight. This peroxidised graphite was then subjected to oxidation by Hummers' method. The oxidised graphite powder (20 g) was put into cold (0° C.) concentrated H₂SO₄ (460 mL). KMnO₄ (60 g) was added gradually with stirring and cooling, so that the temperature of the mixture was not allowed to reach 20° C. The mixture was then stirred at 35° C. for 2 hours, and distilled water (920 mL) was added. In 15 min, the reaction was terminated by the addition of a large amount of distilled water (2.8 L) and 30% H₂O₂ solution (50 mL), after which the colour of the mixture changed to bright yellow. The mixture was filtered and washed with 1:10 HCl solution (5 L) in order to remove metal ions. The graphite oxide product was suspended in distilled water to give a viscous, brown, 2% dispersion, which was subjected to dialysis to completely remove metal ions and acids. As-synthesized graphite oxide was suspended in water to give a brown dispersion, which was subjected to dialysis to completely remove residual salts and acids. Ultrapure Milli-Q water was used in all experiments. As-purified graphite oxide suspensions were then dispersed in water to create a 0.05 wt % dispersion. Exfoliation of graphite oxide to GO was achieved by ultrasonication of the dispersion using a Brandson Digital Sonifier (S450D, 500W, 30% amplitude) for 30 min. The obtained brown dispersion was then subjected to 30 min of centrifugation at 3,000 r.p.m. to remove any unexfoliated graphite oxide (usually present in a very small amount) using an Eppendorf 5702 centrifuge with a rotor radius of 14 cm.

### Preparation of Porous Graphene Oxide Films:

The graphene oxide solution was used to prepare porous graphene oxide (GO) films via three different film synthesis techniques. The prepared GO films were then subjected to a reduction process by irradiation with a laser diode or femtosecond laser to produce a graphene-based film comprising sheets of reduced graphene oxide (rGO).

### Example 1: Formation of Porous GO Film Formed by Filtration and Reduction of the GO Film by Laser Diode

The graphene oxide solution prepared above (the total weight of graphene oxide used is 1 mg) was used to made graphene oxide film by using filtration method (Sigma-Aldrich® vacuum filtration assembly, for 47 mm filter) through an Anodisc membrane filter (47 mm in diameter, 0.2 mm pore size; Whatman). A fully dried porous GO film was achieved in approximately 5 hours at ambient conditions.

A laser diode (650 nm, 200 mW) mounted on a homemade 3D printer frame (Prusa i3) was used to prepare a reduced graphene oxide (rGO) film. The prepared graphene oxide film was reduced by using the laser diode working at 30 mW power focused by a 10×, 0.25 NA objective with a scanning speed of 2 mm/s. The pattern was designed using Inscape or Coreldraw, then converted to Python codes by a homemade program.

Irradiation by laser diode produced a porous graphene-based films comprising reduced graphene oxide (rGO). If desired, multiple writing processes were performed to further reduce the graphene oxide film.

### Example 2: Formation of Porous GO Film Formed by Filtration and Reduction of the GO Film by Femtosecond Laser

Following the procedure described in Example 1, a porous GO film was formed by filtration.

A femtosecond laser (Coherent Libra, 800 nm, 10 kHz repetition rate, 3 W output power) working at 10 μW power focused by a high numerical aperture objective (100×0.85 NA) was used to prepare a graphene-based film comprising reduced graphene oxide (rGO). The prepared graphene oxide film was mounted on a 3D nanoscanning stage (Physik Instrumente P-517) and scanned at 10 μm/s. The scanning stage was driven by a homemade Labview program. The pattern was designed as bitmap and converted to a txt file by a homemade Matlab program.

Irradiation by femtosecond laser produced a porous graphene-based film comprising reduced graphene oxide (rGO).

### Example 3: Formation of Porous GO Film Formed by Self-Assembly and Reduction of the GO Film by Laser Diode

A glass slide substrate was sonicated in acetone, methanol and Milli-Q water for 5 minutes to fully clean the surface. The following steps were then performed: (1) the substrate was immersed a 2% poly(diallyldimethylammonium chloride) (PDDA) water solution for 1 minute and then taken out; (2) the PDDA-modified substrates was cleaned by soaking in Milli-Q water to remove excess PDDA at the surface and completely dried by compressed air, (3) the dried substrate was immersed in 5 mg/ml graphene oxide solution for 1 minute and then take out, (4) the graphene-oxide modified substrate was soaked in Milli-Q water and dried by compressed air. Steps (1) to (4) were repeated for N times to get N self-assembled layers. In this way, a self-assembled porous graphene oxide film was made.

The self-assembled GO film was reduced by using the laser diode according to the procedure described in Example 1 to form a porous graphene-based film comprising reduced graphene oxide (rGO).

### Example 4: Formation of Porous GO Film Formed by Self-Assembly and Reduction of the GO Film by Femtosecond Laser

Following the procedure described in Example 3, a porous GO film was formed by self-assembly.

The GO film was then subjected to a reduction by femtosecond laser following the procedure described in Example 2 to form a porous graphene-based film comprising reduced graphene oxide (rGO).

### Example 5: Formation of Porous GO Film Formed by Drop Casting and Reduction of the GO Film by Laser Diode

A glass slide substrate was sonicated in acetone, methanol and Milli-Q water for 5 minutes to fully clean the surface. A 5 mg/ml graphene oxide solution was dropped onto the surface of the substrate to cover the whole surface. The resulting sample was dried in fume hood for 8 hours in room temperature to produce a porous graphene oxide (GO) film.

The prepared GO film was reduced by using the laser diode according to the procedure described in Example 1 to form a porous graphene-based comprising reduced graphene oxide (rGO).

### Example 6: Formation of Porous GO Film Formed by Drop Casting and Reduction of the GO Film by Femtosecond Laser

Following the procedure described in Example 5, a porous GO film was formed by drop casting.

The GO film was then subjected to a reduction by femtosecond laser following the procedure described in Example 2 to form a porous graphene-based film comprising reduced graphene oxide (rGO).

### Results:

Porous reduced graphene oxide films prepared in the above examples were analysed by Raman spectroscopy and X-ray photo-electron spectroscopy (XPS). Some results are discussed below.

### Laser Diode Reduction of Porous GO Films Prepared by Filtration Method (Raman and XPS)

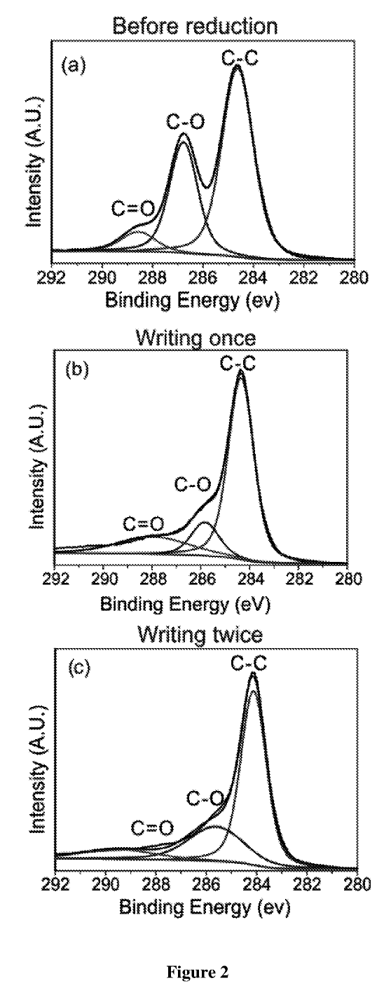

The X-ray photo-electron spectroscopic (XPS) results of the porous GO film produced in accordance with Example 1 and reduced by laser diode (wavelength=785 nm, power=18 mW) is shown in FIG. 2. As one can see in FIG. 2, the strength of the C—O bond peak is significantly reduced by the resulted C:O ratio and the percentage of the C—C bonds (including sp² and sp³ bonding). After irradiation by writing the GO film with laser diode twice, the reduction results slightly improved.

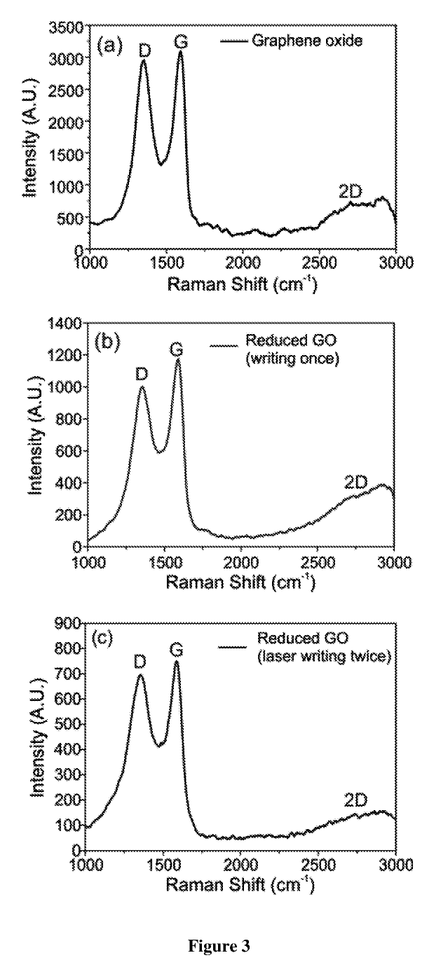

The Raman spectrum of the GO film produced by filtration technique is shown in FIG. 3(a). The spectra of a porous graphene-based film comprising reduced graphene oxide (rGO) produced by irradiation with laser diode (LD) either once and twice is shown in FIGS. 3(b) and 3(c), respectively. The LD reduction significantly decreased the I_{D}/I_{G} ratio, which corresponds to lower defect density. After second reduction, the I_{D}/I_{G} ratio is increased slightly.

### Femtosecond Laser Reduction of Porous GO Films Prepared by the Self-Assembly Method (Raman Spectra)

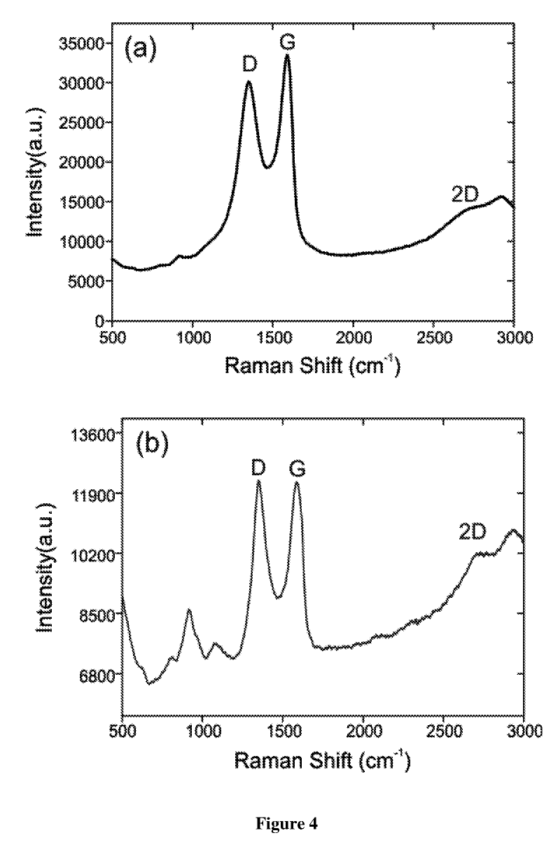

The Raman spectrum of the porous GO film produced in accordance with Example 4 is shown in FIG. 4(a). The GO film reduced by femtosecond laser (wavelength=800 nm, repetition numerical simulation rate=10 kHz, pulse width=85 fs) is shown in FIG. 4(b).

As seen in FIG. 4(b), the I_{D}/I_{G} ratio increased slightly after laser reduction, however, one can see significantly increase of the I_{2D}/I_{G} ratio which confirms the formation of sp² graphene domains.

### Femtosecond Laser Reduction of Porous GO Films Prepared by the Drop-Casting Method (Raman and XPS)

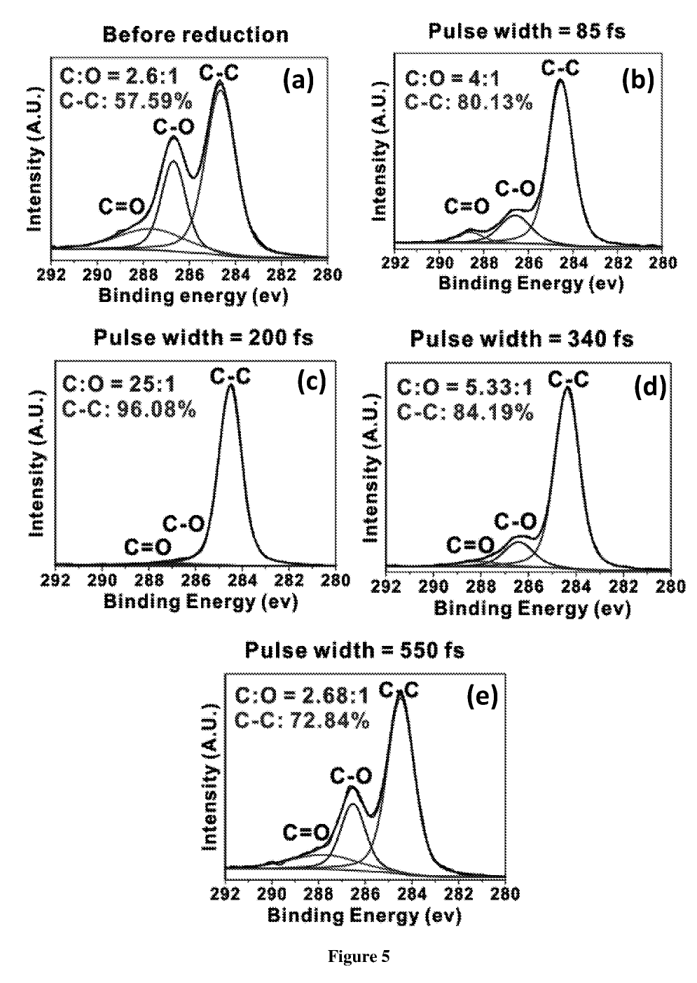

The X-ray photo-electron spectroscopic (XPS) results of the drop-casted film produced in accordance with Example 6 and reduced by femtosecond laser (wavelength=800 nm, repetition rate=10 kHz) with different pulse width is shown in FIG. 5. As one can see in FIG. 5, the resultant C:O ratio and the percentage of the C—C bonds (including sp² and sp³ bonding) are affected by the pulse width.

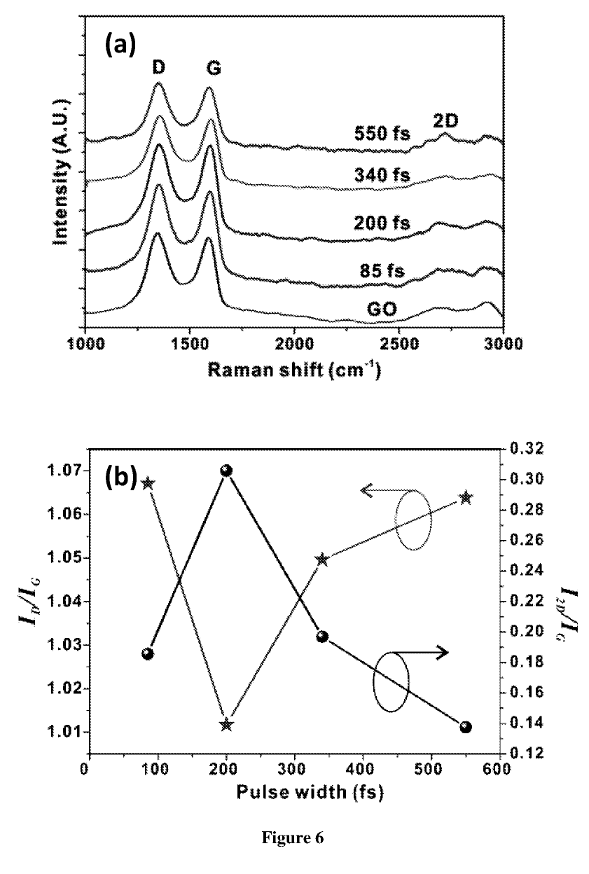

The corresponding Raman spectra are shown in FIG. 6(a). The I_{D}:I_{G} ratio showing the defect density and the I_{2D}:I_{G} ratio showing the formation of sp² graphene domain are shown in FIG. 6(b).

### Changes in Pore Size and Interlayer Spacing

Changes in pore size and interlayer spacing produced as result of the reduction of oxygen containing functional groups in a graphene oxide film was estimated in a simulation experiment.

In the simulation, it was assumed that a 2 μm thick graphene oxide (GO) film (20 mm by 20 mm) is placed on a SiO₂ substrate. The thermal capacity and thermal conductivity of the GO film are set to be 4.41×10⁶J/m³K and 8.8 W/mK, respectively. The refractive index and extinction coefficient is measured using ellipsometer, which are used to calculate the reflection and absorption of the incident light using Fresnel equations. The pulse width of the incident light is 100 fs, the average power is scanned. As the repetition rate of the laser is assumed to be 10 kHz and the heat decade of the GO film is in the time frame of nanoseconds, the temperature decreases to room temperature (the initial temperature) before the next pulse comes. Therefore, only a single pulse is considered in the simulation. In this way, the temperature profile in the GO film irradiated by a single pulse can be calculated. By knowing the maximal temperature, the reduction extend according to the temperature is be calculated. In this way, the interlayer spacing is estimated. Further, the temperature profile is used to estimate the region where the sp³ C—C bonds break. As a result, the pore size is also calculated.

### Example 7: Effect of Laser Power on Interlayer Spacing

Graphene oxide was synthesized from natural graphite (SP-1, Bay Carbon) by a modified Hummers method. As-synthesized graphite oxide was suspended in water to give a brown dispersion, which was subjected to dialysis to completely remove residual salts and acids. Ultrapure Milli-Q water was used in all experiments. As purified graphene oxide suspensions were then dispersed in water to create a 0.05 wt % dispersion. Exfoliation of graphite oxide to GO was achieved by ultrasonication of the dispersion using a Brandson Digital Sonifier (S450D, 500 W, 30% amplitude) for 30 min. The obtained brown dispersion was then subjected to 30 min of centrifugation at 3,000 r.p.m. to remove any unexfoliated graphite oxide (usually present in a very small amount) using an Eppendorf 5702 centrifuge with a rotor radius of 14 cm.

Graphene oxide film was synthesised by using the GO solution, in which the weight of GO was 12 mg in total. A GO film was made by filtration of the GO dispersion through a polymer filter (polyethersulfone (PES) membrane filters, 0.03 Micron pore size, 47 mm, Sterlitech).

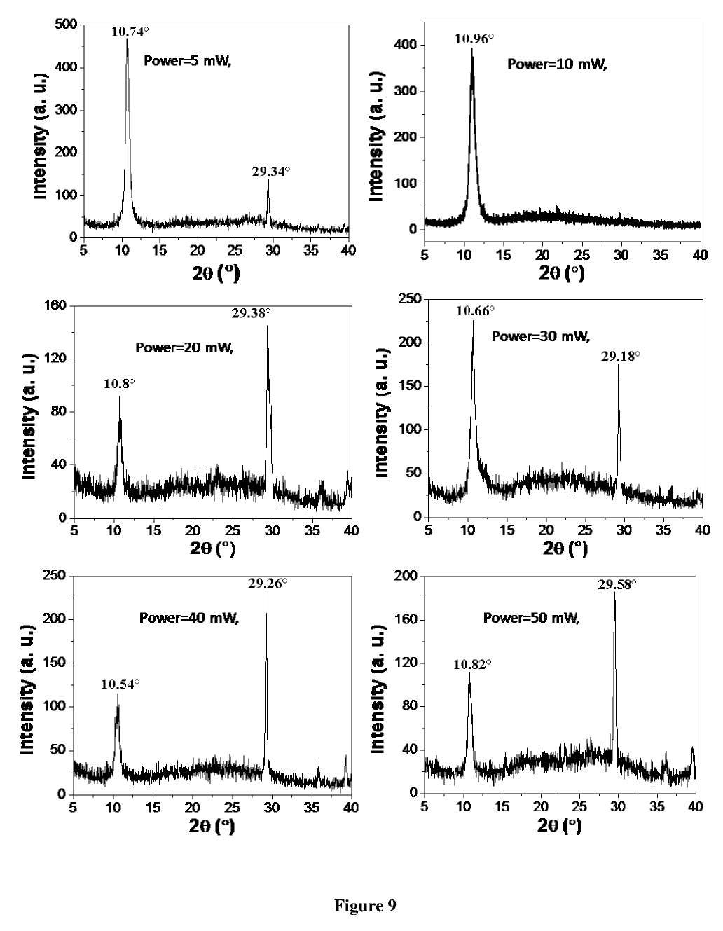

The GO film on PES filter is processed by using of UV laser diode, 405 nm, continuous wave, which is mounted on a 3D printing setup (home made) and collimated by a lens (0.8 mm focal lens). The scanning speed of the laser is 2 mm/s with different laser power. The layer spacing is measured by the x-ray diffraction (XRD) equipment (Bruker D8 Discover). XRD peaks are shown in FIG. 9, in which the diffraction peaks indicate the layer spacing according to the formula:

$$d = \frac{λ}{2 sin θ}$$

where λ is the wavelength of x-ray source, which is 0.15418 nm in this case. In addition the intensity of the peak indicates the percentage of the domain. In this way, the effective layer spacing can be calculated according to the following formula:

dₑ=d₁f₁+d₂f₂

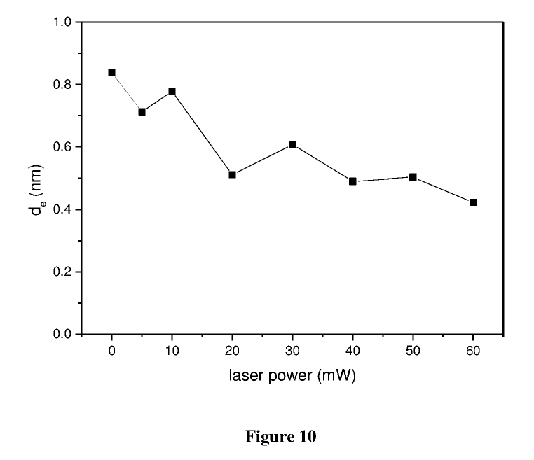

The results of the layer spacing calculation are shown in FIG. 10. As can be seen in FIG. 10, irradiation of the GO film by a laser working at a range of different power can produce different interlayer spacing distances in the resulting graphene-based film. In particular, it was found that when the porous GO film was irradiated, the interlayer spacing in the film successively decreased from an initial value of about 0.85 nm for the original, untreated GO film (where laser power=zero (0)) when a higher laser power was used. By varying the laser power, it is possible to tune the interlayer spacing in a graphene-oxide film within a broad range.

### Example 8: Effect of Laser Pulse Width on Defect Density

Graphene oxide was synthesized from natural graphite (SP-1, Bay Carbon) by a modified Hummers method. As-synthesized graphite oxide was suspended in water to give a brown dispersion, which was subjected to dialysis to completely remove residual salts and acids. Ultrapure Milli-Q water was used in all experiments. As purified graphene oxide suspensions were then dispersed in water to create a 0.05 wt % dispersion. Exfoliation of graphite oxide to GO was achieved by ultrasonication of the dispersion using a Brandson Digital Sonifier (S450D, 500 W, 30% amplitude) for 30 min. The obtained brown dispersion was then subjected to 30 min of centrifugation at 3,000 r.p.m. to remove any unexfoliated graphite oxide (usually present in a very small amount) using an Eppendorf 5702 centrifuge with a rotor radius of 14 cm.

Graphene oxide film was synthesised by using the GO solution, in which the weight of GO was 3 mg in total. A GO film was made by filtration of a dispersion through a polymer filter (polyethersulfone (PES) membrane filters, 0.03 Micron pore size, 47 mm, Sterlitech).

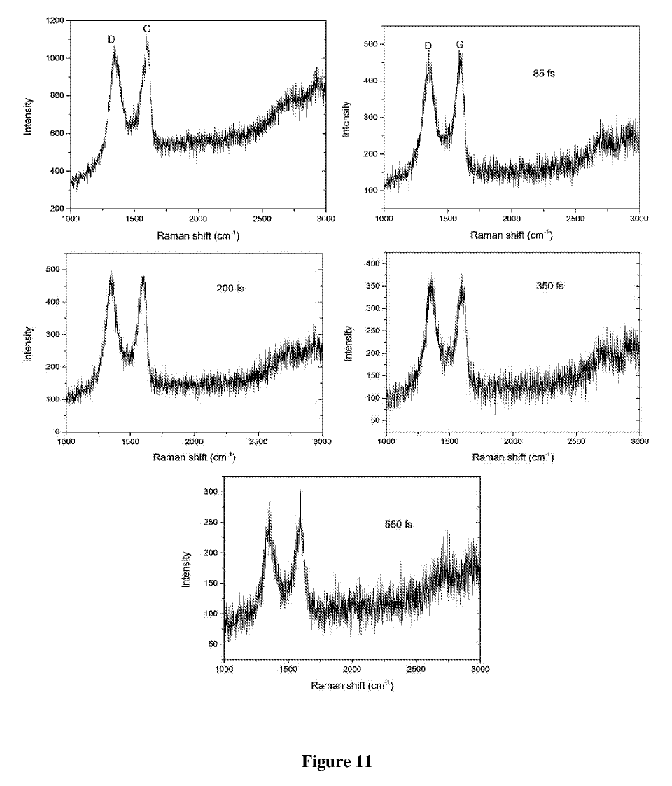

The GO film was transferred onto a cover glass substrate mounted on a 3D piezo scanning stage (Physik instrumente) and processed by a femtosecond laser (Coherent, Libra, 800 nm) focused by a 1.4 numerical aperture (NA) objective (Olympus UPLSAPO 100X). Tuning the effective defects size with femtosecond (fs) laser (power 10 μW) at 800 nm wavelength, 10 kHz repetition rate with different pulse widths. The scanning speed is fixed at 10 μm/s. The Raman spectra are measured by Renishaw inVia Raman microscope with a continuous wave (CW) laser at 532 nm with 0.1 mW power focused by an objective (50×, 0.75NA Leica). The Raman spectra of GO film reduced by femtosecond laser with different pulse width is shown in FIG. 11.

The defect density in the reduced films was calculated according to the following equation:

$${n}_{D} ( {cm}^{- 2} ) = \frac{( 1.8 \pm 0.5 ) \times {10}^{22}}{{λ}_{L}^{4}} ( \frac{{I}_{D}}{{I}_{G}} )$$

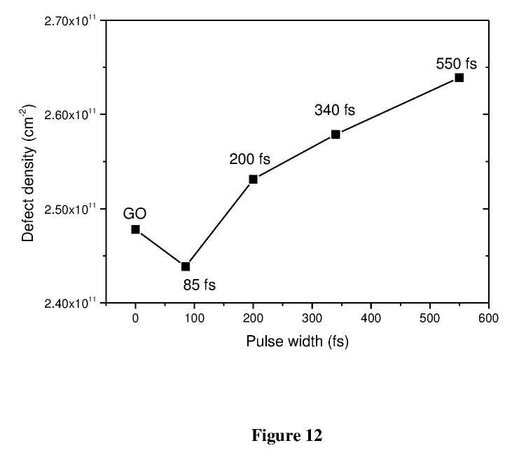

The effect of laser pulse width on defect density is shown in FIG. 12.

### Example 9: Formation of 3D Film

Graphene oxide was synthesized from natural graphite (SP-1, Bay Carbon) by a modified Hummers method. As-synthesized graphite oxide was suspended in water to give a brown dispersion, which was subjected to dialysis to completely remove residual salts and acids. Ultrapure Milli-Q water was used in all experiments. As purified graphene oxide suspensions were then dispersed in water to create a 0.05 wt % dispersion. Exfoliation of graphite oxide to GO was achieved by ultrasonication of the dispersion using a Brandson Digital Sonifier (S450D, 500 W, 30% amplitude) for 30 min. The obtained brown dispersion was then subjected to 30 min of centrifugation at 3,000 r.p.m. to remove any unexfoliated graphite oxide (usually present in a very small amount) using an Eppendorf 5702 centrifuge with a rotor radius of 14 cm.

Graphene oxide film was synthesised by using the GO solution, in which the weight of GO was 12 mg in total. A GO film was made by filtration of a dispersion through a polymer filter (polyethersulfone (PES) membrane filters, 0.03 Micron pore size, 47 mm, Sterlitech).

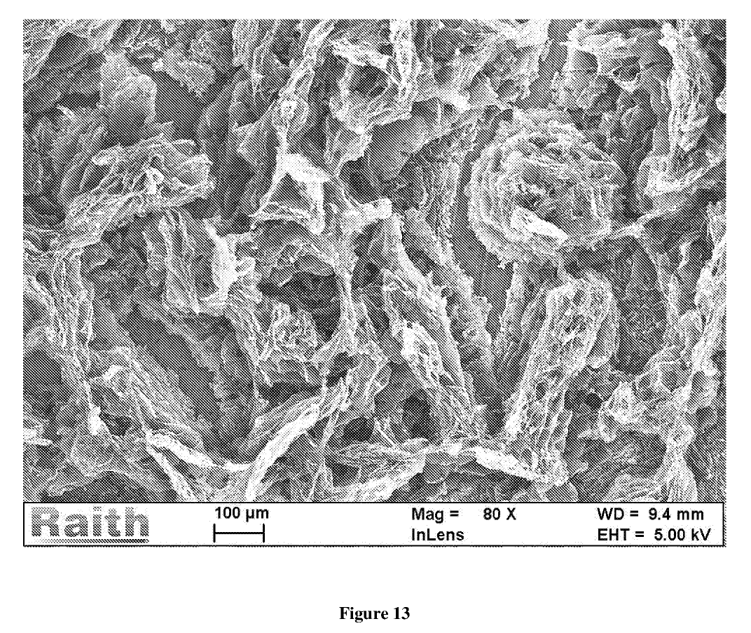

The GO film on PES filter is processed by using of Red laser diode, 650 nm, continuous wave, which is mounted on a 3D printing setup (home made) and collimated by a lens (0.8 mm focal lens). The scanning speed of the laser is 2 mm/s with 60 mW power. The SEM image is taken by RAITH150 Two electron beam lithography (EBL) system. The SEM image of the 3D film is shown in FIG. 13.

### Example 10: Formation of Crosslinked, Multi-Zone Film

Graphene oxide was synthesized from natural graphite (SP-1, Bay Carbon) by a modified Hummers method. As-synthesized graphite oxide was suspended in water to give a brown dispersion, which was subjected to dialysis to completely remove residual salts and acids. Ultrapure Milli-Q water was used in all experiments. As purified graphene oxide suspensions were then dispersed in water to create a 0.05 wt % dispersion. Exfoliation of graphite oxide to GO was achieved by ultrasonication of the dispersion using a Brandson Digital Sonifier (S450D, 500 W, 30% amplitude) for 30 min. The obtained brown dispersion was then subjected to 30 min of centrifugation at 3,000 r.p.m. to remove any unexfoliated graphite oxide (usually present in a very small amount) using an Eppendorf 5702 centrifuge with a rotor radius of 14 cm.

Before film synthesis, a polyol crosslinker, propylene glycol (PG) (Sigma-Aldrich) is added to the GO solution (0.01 ml/mg GO). Graphene oxide film was synthesised by using the GO solution, in which the weight of GO was 12 mg in total. A GO film was made by filtration of a dispersion through a polymer filter (polyethersulfone (PES) membrane milters, 0.03 Micron pore size, 47 mm, Sterlitech).

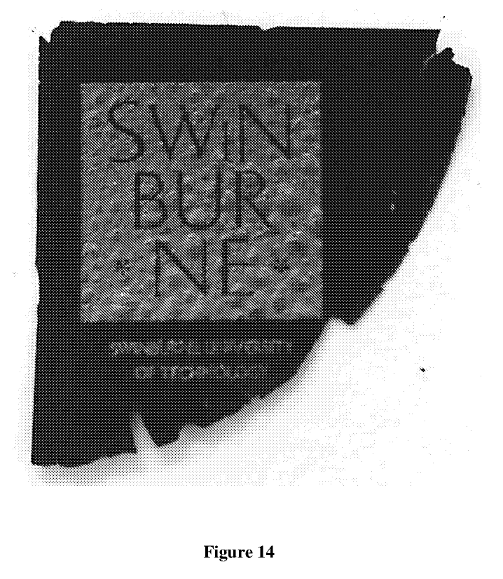

The GO film was transferred to polyester (PET) substrate (250 μm thick) and processed by using of red laser diode, 650 nm, continuous wave, which is mounted on a 3D printing setup (home made) and collimated by a lens (0.8 mm focal lens). The scanning speed of the laser is 2 mm/s with laser power of 30 mW. The GO film was simultaneously reduced and crosslinked by the laser processing. An image of the resultant graphene-based film is shown in FIG. 14.

It is to be understood that various other modifications and/or alterations may be made without departing from the spirit of the present invention as outlined herein.

1. A process for preparing a porous graphene-based film comprising the steps of:
providing a porous graphene oxide film comprising a multilayer array of graphene oxide sheets; and
subjecting the graphene oxide film to a photo-reduction process whereby an oxygen containing functional group situated (i) in a pore of a graphene oxide sheet and/or (ii) in between two or more graphene oxide sheets is reduced, to thereby form a porous graphene-based film comprising at least one reduced graphene oxide sheet,
wherein the reduced graphene oxide sheet has a pore of a different size and/or is separated from a sheet overlapping it by a different interlayer distance, relative to a corresponding graphene oxide sheet in the graphene oxide film prior to the photo-reduction.

2. A process according to claim 1, wherein the photo-reduction process reduces an oxygen containing functional group situated both in a pore of a graphene oxide sheet and in between two or more graphene oxide sheets.

3. A process according to claim 1, wherein the graphene oxide film is irradiated with a laser beam to reduce one or more oxygen containing functional groups.

4. A process according to claim 3, wherein the graphene oxide film is irradiated with a laser beam selected from a continuous-wave (CW) laser beam and a pulsed laser beam.

5. A process according to claim 3, wherein a selected zone of the porous graphene oxide film is irradiated by a laser beam to reduce an oxygen containing functional group situated (i) in a pore of a graphene oxide sheet and/or (ii) in between two or more graphene oxide sheets in the selected zone and thereby alter the pore size and/or sheet interlayer distance in the selected zone by forming at least one reduced graphene oxide sheet in the selected zone.

6. A process according to claim 3, wherein the irradiation parameters of the laser beam is controlled to irradiate a first zone of the graphene oxide film under a first condition, and a second zone of the graphene oxide film under a second condition, to thereby form a porous graphene-based film having at least two different zones of different pore size and/or sheet interlayer distance.

7. A process according to claim 1, wherein the porous graphene-based film is crosslinked.

8. A process according to claim 7, wherein the porous graphene-based film is crosslinked with a polyol.

9. A process according to claim 8, wherein the polyol is selected from the group consisting of ethylene glycol, 1,2-propylene glycol, butylene glycol, 1,6-hexalene glycol, neopentyl glycol, glycerol and pentaerythritol.

10. A process according to claim 1, wherein the graphene oxide film comprises a crosslinking compound and wherein irradiation of the graphene oxide film crosslinks the film and reduces at least one oxygen-containing functional group,

11. A process according to claim 1, wherein irradiation of the graphene oxide film further selectively removes carbon atoms from the basal plane of a graphene oxide sheet to thereby generate one or more defect openings in the plane of the sheet.

12. A process according to claim 1, further comprising the step of irradiating the porous graphene-based film under conditions that selectively remove carbon atoms from the basal plane of a sheet in the graphene-based film to thereby generate one or more defect openings in the plane of the sheet.

13. A process according to claim 1, wherein the graphene oxide film has a thickness of in a range of from about 30 nm to about 3 μm.

14. A process according to claim 1, wherein the photo-reduction process generates gases in situ that modifies the orientation of one or more graphene-based sheets, thereby forming a graphene-based film having a 3D structure.

15. A process according to claim 14, further comprising the step of irradiating the 3D graphene-based film with a laser beam to form one or more passages extending through the 3D film.

16. A process according to claim 15, wherein the laser beam is emitted by an infrared (IR) laser.

17. A process according to claim 15, wherein the passages have a diameter ranging in size from nanometer (nm) to micron (mm).

18. A porous graphene-based film or a filtration membrane including the porous graphene-based film with the porous graphene-based film prepared by the process of claim 1.

19. A filtration membrane comprising:
a porous multi-zone graphene-based film comprising;
a reduced graphene oxide zone comprising porous reduced graphene oxide, and
at least one other zone comprising porous graphene oxide or porous reduced graphene oxide,
wherein the at least one other zone is of a different porosity than the reduced graphene oxide zone.

20. A filtration membrane according to claim 19 further comprising a substrate with the porous multi-zone graphene-based film supported on the substrate.

21. A porous multi-zone graphene-based film comprising:
a reduced graphene oxide zone comprising porous reduced graphene oxide; and
at least one other zone comprising porous graphene oxide or porous reduced graphene oxide,
wherein the at least one other zone is of a different porosity than the reduced graphene oxide zone.

22. A multi-zone graphene-based film according to claim 21, comprising at least two different reduced graphene oxide zones, wherein the two different reduced graphene zones have a different porosity to one another.

23. A multi-zone graphene-based film according to claim 22, wherein the different porosity in the different reduced graphene oxide zones is provided by pores in one or more sheets of a reduced graphene oxide zone being of a different size than that of pores in another reduced graphene oxide zone.

24. A multi-zone graphene-based film according to claim 22, wherein the different porosity in the different reduced graphene oxide zones is provided by two or more sheets in a reduced graphene oxide being separated by an interlayer spacing that is different than that of sheets in another reduced graphene oxide zone.

25. A multi-zone graphene-based film according to claim 22, wherein each of the different reduced graphene oxide zones comprises a reduced graphene oxide sheet having one or more defect openings in the plane of the sheet, and wherein the defect openings in one reduced graphene oxide zone are of a different size to the defect openings in another reduced graphene oxide zone.

26. A multi-zone graphene-based film according to claim 21, wherein the film is in the form of a 3D structure having multiple zones of different porosity.

27. A multi-zone graphene-based film according to claim 26, comprising at least two different reduced graphene oxide zones, wherein each of the different reduced graphene oxide zones comprise one or more passages extending through the zone, and wherein said passages in the different reduced graphene oxide zones are of a different size to one another.

28. A multi-zone graphene-based film according to claim 21, which is crosslinked.

29. (canceled)

30. (canceled)

31. A method of removing a target solute from a solution comprising the step of filtering a solution comprising the target solute through the filtration membrane according to claim 19, whereby the target solute is selectively retained by the membrane.
